(19) United States
(12) Patent Application Publication
(10) Pub. No.: US 2026/0136300 A1
(43) Pub. Date: May 14, 2026

(54) UPLINK POWER CONTROL METHOD AND TERMINAL DEVICE

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 19/119,780

(22) PCT Filed: Oct. 9, 2023
(86) PCT No.: PCT/CN2023/123619

§ 371 Date: Apr. 10, 2025

(30) Foreign Application Priority Data
Oct. 10, 2022 (CN) 202211235394.X

(51) Int. Cl. H04W 52/14

(52) U.S. Cl. CPC H04W 52/146

(57) ABSTRACT

This disclosure discloses an uplink power control method and a terminal device. The method includes the following. A network device configures multiple uplink resource locations for uplink transmission. A terminal device obtains multiple uplink resource locations configured for uplink transmission, and determines uplink power control to be used for each of the multiple uplink resource locations.

### CROSS-REFERENCE TO RELATED APPLICATION(S)

This application is a National Stage of International Application No. PCT/CN2023/123619, field on Oct. 9, 2023, which claims priority to Chinese Patent Application No. 202211235394.X, filed on Oct. 10, 2022, both of which are incorporated by reference herein.

### TECHNICAL FIELD

This disclosure relates to the field of communication technology, in particular to an uplink power control method and a terminal device.

### BACKGROUND

Uplink power control is introduced in a standard protocol specified by the 3rd generation partnership project (3GPP).

The uplink power control can be used to determine a transmit power for uplink transmission, so as to ensure signal receiving performance of a network device with the minimum transmit power, thereby minimizing interference to the network device.

However, with increasingly complex and diverse communication scenarios, the transmission may suffer from different types of interference. For example, these types of interference include cross link interference (CLI), inter-subband interference between network devices, intra-subband interference between network devices, self-interference, inter-subband interference between terminal devices, and intra-subband interference between terminal devices. Since the transmission suffers from different types of interference, uplink power control for uplink transmission becomes more complex. Therefore, further study is needed regarding how to enhance the uplink power control in this case to improve flexibility and operability of the uplink power control and ensure uplink transmission performance and reliability under different types of interference.

### SUMMARY

In a first aspect, an uplink power control method is provided in this disclosure. The method includes the following. Multiple uplink resource locations configured for uplink transmission are obtained. Uplink power control to be used for each of the multiple uplink resource locations is determined.

In a second aspect, an uplink power control method is provided in this disclosure. The method includes the following. Multiple uplink resource locations for uplink transmission are configured, where uplink power control is used for each of the multiple uplink resource locations.

In a third aspect, a terminal device is provided in the disclosure. The terminal device includes a memory and a processor. The memory is configured to store a computer program or instruction. The processor is coupled with the memory and configured to execute the computer program or instruction to implement the operations of the method in the first aspect.

### BRIEF DESCRIPTION OF THE DRAWINGS

In order to more clearly illustrate the technical solutions in embodiments of the disclosure, the following briefly introduces drawings required in descriptions of embodiments or the prior art.

FIG. 1 is a schematic architectural diagram of a communication system according to embodiments of the disclosure.

FIG. 2 is a schematic structural diagram illustrating physical downlink control channel (PDCCH) reception and physical uplink shared channel (PUSCH) transmission according to embodiments of the disclosure.

FIG. 3 is a schematic structural diagram of time-domain resource locations and frequency-domain resource locations according to embodiments of the disclosure.

FIG. 4 is another schematic structural diagram of time-domain resource locations and frequency-domain resource locations according to embodiments of the disclosure.

FIG. 5 is a schematic flowchart of an uplink power control method according to embodiments of the disclosure.

FIG. 6 is a block diagram illustrating functional units of an uplink power control apparatus according to embodiments of the disclosure.

FIG. 7 is another block diagram illustrating functional units of an uplink power control apparatus according to embodiments of the disclosure.

FIG. 8 is a schematic structural diagram of a terminal device according to embodiments of the disclosure.

FIG. 9 is a schematic structural diagram of a network device according to embodiments of the disclosure.

### DETAILED DESCRIPTION

It may be understood that, the terms “first”, “second”, and the like used in embodiments of the disclosure are used to distinguish different objects rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

The term “and/or” in embodiments of the disclosure describes an association relationship between associated objects, and indicates that there may be three relationships, for example, A and/or B may mean A alone, both A and B exist, and B alone. A and B each may be a singular from or a plural form.

The character “/” in embodiments of the disclosure can indicate that the associated objects are in an “or” relationship. In addition, the symbol “/” may represent a divisor, i.e., perform a division operation. For example, A/B may represent A divided by B.

The term “at least one (item) of” or the like in embodiments of the disclosure refers to any combination of these items, including any combination of a single item or multiple items, and refers to one or multiple, where multiple refers to two or more. For example, at least one (item) of a, b, or c can represent the following seven cases: a; b; c; a and b; a and c; b and c; a, b, and c. a, b, and c each may be an element or a set including one or more elements.

The term “equal to” in embodiments of the disclosure may be used together with “greater than”, which is applicable to a technical solution used in a case of “greater than”; or may be used together with “less than”, which is applicable to a technical solution used in a case of “less than”. It may be noted that, when “equal to” is used together with “greater than”, “equal to” is not used together with “less than”; and when “equal to” is used together with “less than”, “equal to” is not used together with “greater than”.

The terms “of”, “corresponding/relevant”, and “indicated” in embodiments of the disclosure may be used interchangeably sometimes. It may be noted that meanings expressed by the terms are consistent when differences of the terms are not emphasized.

The terms “configure”, “provide”, and the like in embodiments of the disclosure may refer to the same concept.

The term “connection” in embodiments of the disclosure refers to various connection methods, such as direct connection or indirect connection, so as to implement communication between devices, which is not limited herein.

The terms “network” and “system” in embodiments of the disclosure may refer to the same concept, and a communication system is a communication network.

The terms “belonging to”, “having”, “corresponding to”, “associated with”, “mapped to”, and the like in embodiments of the disclosure may refer to the same concept.

The following describes related contents, concepts, meanings, technical problems, technical solutions, beneficial effects, and the like involved in embodiments of the disclosure.

### I. Communication System, Terminal Device, and Network Device

### 1. Communication System

The technical solutions of embodiments of the disclosure may be applicable to various communication systems, for example, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication System (UMTS), a wireless local area network (WLAN), a wireless fidelity (Wi-Fi), a 6th-generation (6G) communication system, or other communication systems.

It may be noted that, a conventional communication system generally supports a limited number (quantity) of connections and therefore is easy to implement. However, with the development of communication technology, a communication system will not only support a conventional communication system but also support, for example, device-to-device (D2D) communication, machine-to-machine (M2M) communication, machine-type communication (MTC), vehicle-to-vehicle (V2V) communication, vehicle to everything (V2X) communication, narrowband internet of things (NB-IoT) communication, etc. Therefore, the technical solutions of embodiments of the disclosure can also be applied to these communication systems.

In addition, the technical solutions of embodiments of the disclosure may be applied to a beamforming scenario, a carrier aggregation (CA) scenario, a dual connectivity (DC) scenario, or a standalone (SA) deployment scenario, etc.

In embodiments of the disclosure, a spectrum used for communication between a terminal device and a network device or a spectrum used for communication between a terminal device and a terminal device may be a licensed spectrum or an unlicensed spectrum, which is not limited herein. In addition, the unlicensed spectrum may be understood as a shared spectrum, and the licensed spectrum may be understood as an unshared spectrum.

Since various embodiments of the disclosure are described in connection with a terminal device and a network device, the terminal device and the network device involved will be described in detail below.

### 2. Terminal Device

The terminal device may be a device with transceiver functions, or may be referred to as a terminal, a user equipment (UE), a remote UE, a relay UE, an access terminal device, a subscriber unit, a subscriber station, a mobile station, a remote station, a mobile device, a user terminal device, a smart terminal device, a wireless communication device, a user agent, or a user apparatus. It may be noted that, a relay device is a terminal device capable of providing a relay forwarding service for other terminal devices (including a remote terminal device).

For example, the terminal device may be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, or a wireless terminal device in smart home, etc.

For another example, the terminal device may also be a cellular radio telephone, a cordless telephone, a session initiation protocol (SIP) telephone, a wireless local loop (WLL) station, a personal digital assistant (PDA), various devices having wireless communication functions such as a handheld device, a computing device or other processing devices coupled with a wireless modem, an in-vehicle device, a wearable device, a terminal device in a next-generation communication system (such as an NR communication system, a 6G communication system), or a terminal device in a future evolved public land mobile network (PLMN), etc., which is not limited herein.

In some possible implementations, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In some possible implementations, the terminal device may include a device with wireless communication functions, such as a system-on-chip (SOC), a chip, a chip module, etc. Exemplarily, the SOC may include a chip, or may also include other discrete components.

### 3. Network Device

The network device may be a device with transceiver functions for communicating with the terminal device.

In some possible implementations, the network device may be responsible for radio resource management (RRM), quality of service (QoS) management, data compression and encryption, and data transmission and reception at an air-interface side.

In some possible implementations, the network device may be a base station (BS) in a communication system or a device deployed on a radio access network (RAN) for providing wireless communication functions.

For example, the network device may be an evolutional node B (eNB or eNodeB) in an LTE communication system, a next-generation evolved node B (ng-cNB) in an NR communication system, a next-generation node B (gNB) in an NR communication system, a master node (MN) in a DC architecture, a secondary node (SN) in a DC architecture, etc, which is not limited herein.

In some possible implementations, the network device may also be a device in a core network (CN), such as an access and mobility management function (AMF), a user plane function (UPF), etc., or may be an access point (AP) in a WLAN, a relay station, a communication device in a future evolved PLMN, a communication device in an NTN network, etc.

In some possible implementations, the network device may include an apparatus for providing wireless communication functions for the terminal device, such as an SOC, a chip, a chip module, etc. Exemplarily, the SOC may include a chip, or may include other discrete components.

In some possible implementations, the network device may communicate with an internet protocol (IP) network, for example, the Internet, a private IP network, or other data networks.

In some possible implementations, the network device may be an independent node so as to implement functions of the base station, or the network device may include two or more independent nodes to implement functions of the base station. For example, the network device includes a centralized unit (CU) and a distributed unit (DU), such as a gNB-CU and a gNB-DU. Further, in some other embodiments of the disclosure, the network device may further include an active antenna unit (AAU). The CU can implement some functions of the network device, and the DU can implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency (RF) processing functions, and active-antenna-related functions. Since RRC layer information will eventually become PHY layer information, or be transformed from PHY layer information, in such network deployment, it may be considered that higher-layer signaling, such as RRC signaling, is generated by the CU, is transmitted by the DU, or transmitted by the DU and the AAU. It can be considered that, the network device may include at least one of the CU, the DU, or the AAU. In addition, the CU may be categorized into a network device in a RAN, or may be categorized into a network device in a CN, which is not limited herein.

In some possible implementations, the network device may be any one of multiple stations that perform coherent joint transmission (CJT) with the terminal device, another station other than the multiple stations, or another network device that performs network communication with the terminal device, which is not limited herein. Multi-station coherent joint transmission may be joint coherent transmission of multiple stations, transmission of different data belonging to the same physical downlink shared channel (PDSCH) from different stations to the terminal device, or transmission by multiple stations virtualized into one station. Names with the same meaning specified in other standards are also applicable to the disclosure. That is, the names of these parameters are not limited in the disclosure. The station in multi-station coherent joint transmission may be a remote radio head (RRH), a transmission and reception point (TRP), a network device, etc., which is not limited herein.

In some possible implementations, the network device may be any one of multiple stations that perform incoherent joint transmission with the terminal device, another station other than the multiple stations, or another network device that performs network communication with the terminal device, which is not limited herein. Multi-station incoherent joint transmission may be joint incoherent transmission of multiple stations, transmission of different data belonging to the same PDSCH from different stations to the terminal device, or transmission of different data belonging to the same PDSCH from different stations to the terminal device. Names with the same meaning specified in other standards are also applicable to the disclosure. That is, the names of these parameters are not limited in the disclosure. The station in multi-station incoherent joint transmission may be a RRH, a TRP, a network device, etc., which is not limited herein.

In some possible implementations, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In some possible implementations, the network device may provide services for a cell. The terminal device in the cell can communicate with the network device through transmission resources, such as spectrum resources. The cell may be a macro cell, a small cell, a metro cell, a micro cell, a pico cell, a femto cell, etc.

### 4. Exemplary Description

The communication system in embodiments of the disclosure is exemplified below.

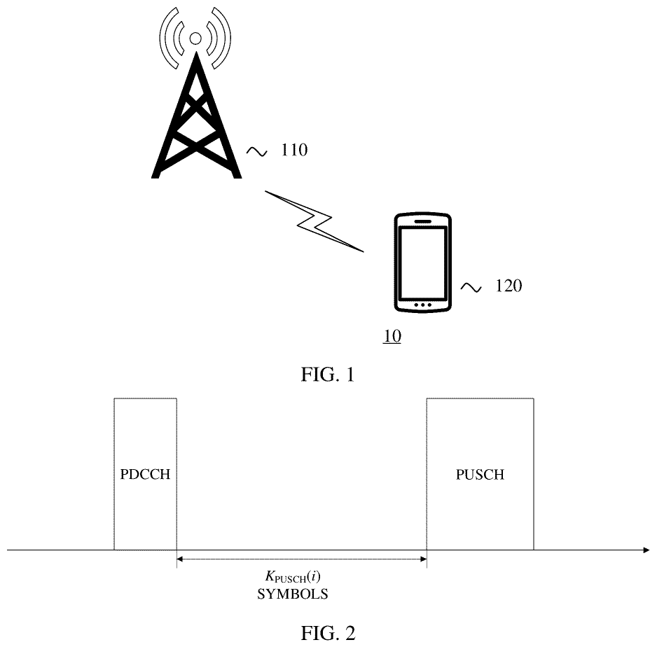

Exemplarily, referring to FIG. 1, a network architecture of a communication system in embodiments of the disclosure is illustrated. As illustrated in FIG. 1, a communication system 10 may include a network device 110 and a terminal device 120.

FIG. 1 only illustrates an example of the network architecture of the communication system, and does not constitute a limitation on the network architecture of the communication system in embodiments of the disclosure. For example, the communication system 10 may further include a server or other devices. For another example, the communication system 10 may include multiple network devices and/or multiple terminal devices.

### II. Uplink Power Control

The uplink power control can be used to determine a transmit power for uplink transmission, so as to ensure signal receiving performance of a network device with the minimum transmit power, thereby minimizing interference to the network device. The uplink transmission may include one of: physical uplink shared channel (PUSCH) transmission, physical uplink control channel (PUCCH) transmission, sounding reference signal (SRS) transmission, and physical random access channel (PRACH) transmission.

It may be noted that, a PUSCH/PUCCH/SRS/PRACH transmission occasion i is defined by a slot index

$${n}_{s , f}^{μ}$$

within a frame with system name number SFN, a first symbol S within the slot, and a number of consecutive symbols L.

### 1. PUSCH Transmission

If a terminal device transmits a PUSCH on active uplink bandwidth part (UL BWP) b of carrier f of serving cell c using parameter set configuration with index j and PUSCH power control adjustment state with index l, the terminal device determines the PUSCH transmission power P_{PUSCH,b,f,c}(i, j, q_{d}, l) in PUSCH transmission occasion i as:

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

The meanings of parameters will be described in detail below.

$${P}_{CMAX , f , c} ( i ) \qquad ( 1 )$$

P_{CMAX,f,c}(i) indicates the maximum output power configured for the terminal device for carrier f of serving cell c in PUSCH transmission occasion i.

$${P}_{{O}_{-} PUSCH , b , f , c} ( j ) \qquad ( 2 )$$

P_{O_PUSCH,b,f,c}(j) indicates a target reception power, and

$${P}_{{O}_{-} PUSCH , b , f , c} ( j ) = {P}_{{O}_{-} NOMINAL , PUSCH , f , c} ( j ) + {P}_{{O}_{-} {UE}_{-} PUSCH , b , f , c} ( j ) , \\ where j ∈ \{ 0 , 1 , … , J - 1 \} .$$

P_{O_NOMINAL,PUSCH,f,c}(j) indicates a common configured target reception power, and P_{O_UE_PUSCH,b,f,c}(j) indicates a UE-specific configured target reception power.

Values of P_{O_PUSCH,b,f,c}(j) may vary with different values of index j.

According to values of index j, three cases will be described below.

$$○ 1 j = 0$$

If the terminal device establishes dedicated RRC connection using a Type-1 random access procedure and is not provided a higher-layer parameter P0-PUSCH-AlphaSet or for a PUSCH transmission/retransmission corresponding to a random access response (RAR) UL grant, j=0, P_{O_UE_PUSCH,b,f,c}(0)=0, and P_{O_NOMINAL,PUSCH,f,c}(0)=P_{O_PRE}+Δ_{PREAMBLE,Msg3}. Herein, P_{O_PRE} indicates a target power for reception of a preamble, which is configured by a parameter preambleReceivedTargetPower in system information block 1 (SIB1). Δ_{PREAMBLE,Msg3} is configured by a higher-layer parameter msg3-DeltaPreamble, or if the parameter msg3-DeltaPreamble is not provided, Δ_{PREAMBLE,Msg3}=0.

If the terminal device establishes dedicated RRC connection using a Type-2 random access procedure and is not provided a parameter P0-PUSCH-AlphaSet or for a PUSCH transmission for Type-2 random access procedure, j=0, P_{O_UE_PUSCH,b,f,c}(0)=0, and P_{O_NOMINAL,PUSCH,f,c}(0)=P_{O_PRE}+4_{MsgA_PUSCH}. Herein, P_{O_PRE} indicates a target power for reception of a preamble, which is configured by a parameter msgA-preambleReceivedTargetPower in SIB1 or is configured by a parameter preambleReceivedTargetPower if the parameter msgA-preambleReceivedTargetPower is not provided. Δ_{MsgA_PUSCH} is provided by a parameter msgA-DeltaPreamble, or if the parameter msgA-DeltaPreamble is not provided, Δ_{MsgA_PUSCH}=Δ_{PREAMBLE_Msg3}.

$$○ 2 j = 1$$

For a PUSCH transmission/retransmission configured by a parameter ConfiguredGrantConfig, j=1. P_{O_NOMINAL,PUSCH,f,c}(1) is configured by a parameter p0-NominalWithoutGrant in SIB1, or if the parameter p0-NominalWithoutGrant is not provided in an SIB1, P_{O_NOMINAL,PUSCH,f,c}(1)=P_{O_NOMINAL,PUSCH,f,c}(0). P_{O_UE_PUSCH,b,f,c}(1) is provided by p0 as follows. P0-PUSCH-AlphaSetId is obtained according to a parameter p0-PUSCH-Alpha in ConfiguredGrantConfig, and then p0 corresponding to P0-PUSCH-AlphaSetId is found in a parameter P0-PUSCH-AlphaSet in SIB1.

| | |
|---|---|
| For example, P0-PUSCH-AlphaSet ::= | SEQUENCE { |

| | |
|---|---|
| p0-PUSCH-AlphaSetId | P0-PUSCH-AlphaSetId, |

| | | |
|---|---|---|
| p0 | INTEGER (−16..15) | OPTIONAL, -- Need S |

| | |
|---|---|
| alpha | Alpha |

}
\textcircled{3} j=2

If DCI format 0_0 or DCI format 0_1 does not include an SRS resource indicator (SRI) field, or SRI-PUSCH-PowerControl is not configured, j=2. P_{O_NOMINAL,PUSCH,f,c}(2) is configured by a parameter p0-NominalWithGrant in SIB1, or if the parameter p0-NominalWithGrant is not provided in SIB1, P_{O_NOMINAL,PUSCH,f,c}(2)=P_{O_NOMINAL,PUSCH,f,c}(0). P_{O_UE_PUSCH,b,f,c}(2) is provided by p0 in the first p0-Pusch-AlphaSet in a parameter p0-AlphaSets.

$$○ 4 j ∈ \{ 2 , … , J - 1 \} = {S}_{J}$$

If the terminal device is configured with more than one values of p0-PUSCH-AlphaSetId through SRI-PUSCH-PowerControl, and DCI format 0_1 includes an SRI field, j E {2, . . . , J−1}=S_{J}. P_{O_NOMINAL,PUSCH,f,c}(j) is configured by a parameter p0-NominalWithGrant in SIB1, or if the parameter p0-NominalWithGrant is not provided in SIB1, P_{O_NOMINAL,PUSCH,f,c}(j)=P_{O_NOMINAL,PUSCH,f,c}(0). P_{O_UE_PUSCH,b,f,c}(j) is provided by p0 as follows. The SRI field in DCI format 0_1 is mapped to a parameter sri-PUSCH-PowerControlId, which is then mapped to the corresponding p0 according to an index p0-PUSCH-AlphaSetId.

$${α}_{b , f , c} ( j ) \qquad ( 3 )$$

α_{b,f,c}(j) indicates a pathloss compensation factor. Values of α_{b,f,c}(j) may vary with different values of index j.

$$○ 1 j = 0$$

If the terminal device establishes dedicated RRC connection using a Type-1 random access procedure and is not provided a higher-layer parameter P0-PUSCH-AlphaSet or for a PUSCH transmission/retransmission corresponding to a RAR UL grant, j=0. α_{b,f,c}(0) may be provided by a parameter msgA-Alpha in SIB1 or may be provided by a parameter msg3-Alpha in SIB1. Alternatively, if the parameter msgA-Alpha or the parameter msg3-Alpha is not provided in SIB1, α_{b,f,c}(0)=1.

$$○ 2 j = 1$$

For a PUSCH transmission/retransmission configured by a parameter ConfiguredGrantConfig, j=1. α_{b,f,c}(1) is provided by alpha as follows. P0-PUSCH-AlphaSetId is obtained according to a parameter p0-PUSCH-Alpha in ConfiguredGrantConfig, and then alpha corresponding to P0-PUSCH-AlphaSetId is found in a parameter P0-PUSCH-AlphaSet in SIB1.

$$○ 3 j = 2$$

If DCI format 0_0 or DCI format 0_1 does not include an SRI field, or SRI-PUSCH-PowerControl is not configured, j=2. α_{b,f,c}(2) is provided by alpha in the first p0-Pusch-AlphaSet in a parameter p0-AlphaSets.

$$○ 4 j ∈ \{ 2 , … , J - 1 \} = {S}_{J}$$

If the terminal device is configured with more than one values of p0-PUSCH-AlphaSetId through SRI-PUSCH-PowerControl, and DCI format 0_1 includes an SRI field, j∈{2, . . . , J−1}=Sⱼ. α_{b,f,c}(j) is provided by alpha as follows. The SRI field in DCI format 0_1 is mapped to a parameter sri-PUSCH-PowerControlId, which is then mapped to the corresponding alpha according to an index p0-PUSCH-AlphaSetId.

$${M}_{RB , b , f , c}^{PUSCH} ( i ) \qquad ( 4 )$$

$${M}_{RB , b , f , c}^{PUSCH} ( i )$$

is a bandwidth of the PUSCH resource assignment, which indicates the number of resource blocks (RBs) for PUSCH transmission occasion i on active UL BWP b of carrier f of serving cell c.

$${PL}_{b , f , c} ( {q}_{d} ) \qquad ( 5 )$$

PL_{b,f,c}(q_{d}) is a downlink pathloss estimate calculated by the terminal device according to a reference signal (RS). The RS may be a synchronization signal and physical broadcast channel (PBCH) block (SSB) or a channel state information-reference signal (CSI-RS), and an index of the RS is q. A unit of PL_{b,f,c}(q_{d}) is dB.

### \textcircled{1} Random Access

If the terminal device is not configured with a parameter PUSCH-PathlossReferenceRS, or before the terminal device is configured with dedicated higher-layer parameters, the terminal device calculates PL_{b,f,c}(q) using the SSB as the RS. The SSB has the same index as the one that the terminal device uses to obtain a master information block (MIB).

If the PUSCH transmission is scheduled by a RAR UL grant (i.e., Msg3), or for a PUSCH transmission for the Type-2 random access procedure, the terminal device uses the same RS resource index q_{d} as for a PRACH transmission.

### \textcircled{2} Semi-Persistent Scheduling

For a PUSCH transmission configured by ConfiguredGrantConfig (i.e., semi-persistent scheduling), if a parameter rrc-ConfiguredUplinkGrant is configured, a RS resource index qy is provided by a parameter pathlossReferenceIndex in the parameter rrc-ConfiguredUplinkGrant. In this case, the RS resource belongs to serving cell c or, if a parameter pathlossReferenceLinking is configured, points to a configured serving cell.

For a PUSCH transmission configured by ConfiguredGrantConfig (i.e., semi-persistent scheduling), if a parameter rrc-ConfiguredUplinkGrant is not configured, an SRI field in triggering DCI is mapped to PUSCH-PathlossReferenceRS-Id, and then a RS resource index qa is obtained; when DCI triggering the PUSCH transmission does not include an SRI field, a RS resource index q_{d} is obtained according to PUSCH-PathlossReferenceRS-Id=0. In this case, the RS resource belongs to serving cell c or, if a parameter pathlossReferenceLinking is configured, points to a configured serving cell.

### \textcircled{3} Dynamic Scheduling

If the terminal device is configured with a number of RS resource indexes in a parameter PUSCH-PathlossReferenceRS, and the number of RS resource indexes is at most maxNrofPUSCH-PathlossReferenceRS, the RS resource indexes are indicated by pusch-PathlossReferenceRS-Id, and can include one or both of SSB indexes and CSI-RS indexes. The terminal device can determine, according to pusch-PathlossReferenceRS-Id in PUSCH-PathlossReferenceRS, whether the RS resource index is the SSB index or the CSI-RS index.

If the PUSCH transmission is scheduled by DCI format 0_0, and a parameter PUCCH-Spatialrelationinfo is configured for a PUCCH resource with a lowest index, the terminal device uses the same RS resource index q_{d} as for the PUCCH resource with the lowest index.

If the PUSCH transmission is scheduled by DCI format 0_0, and a spatial setting (a parameter PUCCH-Spatialrelationinfo) is not configured for a PUCCH transmission, or if the PUSCH transmission is scheduled by DCI format 0_1 that does not include an SRI field, or if a parameter SRI-PUSCH-PowerControl is not configured, then a RS resource index q_{d} is obtained according to PUSCH-PathlossReferenceRS-Id=0. In this case, the RS resource belongs to serving cell c or, if a parameter pathlossReferenceLinking is configured, points to a configured serving cell.

PL_{b,f,c}(q)=referenceSignalPower-higher layer filtered RSRP, where referenceSignalPower is configured by a higher-layer parameter, and a reference signal received power (RSRP) filter is configured by a parameter QuantityConfig in rrcReconfiguration signaling.

If periodic CSI-RS reception is not configured, referenceSignalPower is configured by a higher-layer parameter ss-PBCH-BlockPower. If periodic CSI-RS reception is configured, referenceSignalPower is configured by a higher-layer parameter ss-PBCH-BlockPower or powerControlOffsetSS, and the higher-layer parameter powerControlOffsetSS configures a power offset of an CSI-RS relative to an SSB. If the parameter powerControlOffsetSS is not configured, it indicates that a default value of the offset is 0 dB.

$${Δ}_{TF , b , f , c} ( i ) \qquad ( 6 )$$

Δ_{TF,b,f,c}(i) indicates a modulation and coding scheme (MCS) power adjustment, which may be determined according to a parameter deltaMCS in SIB1. If a value of the parameter deltaMCS is enabled, Kₛ=1.25. If the parameter deltaMCS is not provided, Kₛ=0.

If Kₛ=0, Δ_{TF,b,f,c}(i)=0. If Kₛ=1.25, Δ_{TF,b,f,c}(i) is as follows.

$${Δ}_{TF , b , f , c} ( i ) = 10 {log}_{10} ( ( {2}^{BPRE \cdot {K}_{s}} - 1 ) \cdot {β}_{offset}^{PUSCH} )$$

For different cases, the meanings of parameters will be described in detail below.

### \textcircled{1} for a PUSCH with Uplink Data

$$BPRE = {\sum }_{r = 0}^{C - 1} {K}_{r} / {N}_{RE} ; {N}_{RE} = N \cdot {M}_{RB , b , f , c}^{PUSCH} ( i ) \cdot {\sum }_{j = 0}^{{N}_{RB , b , f , c}^{PUSCH} ( i ) - 1} {N}_{sc , data}^{RB} ( i , j ) .$$

C indicates the number of code blocks. Kᵣ indicates a size for the code block. N_{RE} indicates the number of resource elements (REs). N≥1 is configured by a parameter numberOfSlotsTBoMS, and if the parameter numberOfSlotsTBoMS is not provided,

$$N = 1. {N}_{RB , b , f , c}^{PUSCH} ( i )$$

indicates the number of symbols for PUSCH transmission occasion i on active UL BWP b of carrier f of serving cell c.

$${N}_{sc , data}^{RB} ( i , j )$$

indicates the number of subcarriers excluding demodulation reference signals (DMRSs) and phase tracking reference signals (PTRSs) in PUSCH symbol j. If the PUSCH includes uplink data,

$${β}_{offset}^{PUSCH} = 1.$$

### \textcircled{2} for CSI Transmission in a PUSCH without Uplink Data

$$BPRE = {Q}_{m} \cdot R / {β}_{offset}^{PUSCH} \cdot {Q}_{m}$$

indicates the modulation order and is provided by a DCI format, where the DCI schedules the PUSCH transmission that includes CSI and does not include uplink data. R indicates the target code rate and is provided by a DCI format, where the DCI schedules the PUSCH transmission that includes CSI and does not include uplink data. If the PUSCH includes only CSI and does not include uplink data,

$${β}_{offset}^{PUSCH} = {β}_{offset}^{CSI , 1} .$$

$${f}_{b , f , c} ( i , l )$$

f_{b,f,c}(i,l) indicates a PUSCH power control adjustment state.

### \textcircled{1} l

l indicates an index of the PUSCH power control adjustment state.

If a parameter twoPUSCH-PC-AdjustmentStates is configured, l={0, 1}. If the parameter twoPUSCH-PC-AdjustmentStates is not configured, l=0. If the PUSCH transmission is scheduled by a RAR UL grant (i.e., Msg3), l=0.

### a) Semi-Persistent Scheduling (j=1)

For a PUSCH transmission or retransmission configured by ConfiguredGrantConfig, a value of l∈{0, 1} is configured by a higher-layer parameter powerControlLoopToUse.

If the terminal device obtains a transmit power control (TPC) command from DCI format 2_2 scrambled by TPC-PUSCH-RNTI, a value of/may be determined by a closed loop indicator field in DCI format 2_2.

### b) Dynamic Scheduling (j>1)

If the PUSCH transmission is scheduled by DCI format 0_0 or by DCI format 0_1 that does not include an SRI field, or a higher-layer parameter SRI-PUSCH-PowerControl is not configured, l=0.

If an SRI-PUSCH-PowerControl information element (IE) is configured and DCI format 0_1 scheduling the PUSCH transmission includes an SRI field, the SRI field in DCI format 0_1 is mapped to sri-PUSCH-PowerControlId, and then a value of/is determined according to corresponding sri-PUSCH-ClosedLoopIndex.

### c) Calculation of f_{b,f,c}(i,l)

f_{b,f,c}(i,l) can be calculated according to a TPC command as follows.

Calculating f_{b,f,c}(i,l) in a TPC command accumulation manner

If a parameter tpc-Accumulation is not configured or the parameter tpc-Accumulation is configured to be enabled, f_{b,f,c}(i,l) is calculated in the TPC command accumulation manner as follows.

$${f}_{b , f , c} ( i , l ) = {f}_{b , f , c} ( i - {i}_{0} , l ) + {\sum }_{m = 0}^{C ( {D}_{i} ) - 1} {δ}_{PUSCH , b , f , c} ( m , l )$$

In the above, δ_{PUSCH,b,f,c} indicates a value of the TPC command, which can be determined according to accumulated δ_{PUSCH,b,f,c} in Table 1.

$${\sum }_{m = 0}^{C ( {D}_{i} ) - 1} {δ}_{PUSCH , b , f , c} ( m , l )$$

indicates a sum of TPC command values (i.e., accumulation of the TPC command values) in a set Dᵢ, where the set Dᵢ includes C(Dᵢ) TPC command values for the same index l. C (Dᵢ) TPC command values are obtained by the terminal device between K_{PUSCH}(i−i₀)−1 symbols before PUSCH transmission occasion i−i₀ and K_{PUSCH}(i) symbols before PUSCH transmission occasion i, where i₀>0 is the smallest integer for which K_{PUSCH}(i−i₀) symbols before PUSCH transmission occasion i−i₀ are earlier than K_{PUSCH}(i) symbols before PUSCH transmission occasion i.

TABLE 1

| TPC command | Accumulated δ_{PUSCH, b, f, c} | Absolute δ_{PUSCH, b, f, c} |
|---|---|---|
| field | or δ_{SRS, b, f, c} [dB] | or δ_{SRS, b, f, c} [dB] |
| 0 | −1 | −4 |
| 1 | 0 | −1 |
| 2 | 1 | 1 |
| 3 | 3 | 4 |

If a PUSCH transmission is scheduled by DCI format 0_0 or DCI format 0_1, K_{PUSCH}(i) indicates the number of symbols between the last symbol of a physical downlink control channel (PDCCH) reception and the first symbol of the PUSCH transmission, for example, as illustrated in FIG. 2.

If a PUSCH transmission is configured by ConfiguredGrantConfig, a value of K_{PUSCH}(i) is equal to the product of the number of symbols per slot,

$${N}_{symb}^{slot} ,$$

and the minimum value provided by k2 in a parameter PUSCH-ConfigCommon.

Calculating f_{b,f,c}(i,l) in a TPC command absolute-value manner

If a parameter tpc-Accumulation is configured to be disabled, f_{b,f,c}(i,l) is calculated in the TPC command absolute-value manner as follows.

$${f}_{b , f , c} ( i , l ) = {δ}_{PUSCH , b , f , c} ( i , l )$$

In the above, an absolute value of δ_{PUSCH,b,f,c} can be determined according to absolute δ_{PUSCH,b,f,c} in Table 1.

### 2. PUCCH Transmission

If the terminal device transmits a PUCCH on active UL BWP b of carrier f in the primary cell c using PUCCH power control adjustment state with index l, the terminal device determines the PUCCH transmission power P_{PUCCH,b,f,c}(i, qᵤ, q_{d}, l) in PUCCH transmission occasion i as:

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

The meanings of parameters will be described in detail below.

$${P}_{CMAX , f , c} ( i ) \qquad ( 1 )$$

P_{CMAX,f,c}(i) indicates the maximum output power configured for the terminal device for carrier f of primary cell c in PUCCH transmission occasion i.

$${P}_{O \_ PUCCH , B , F , C} ( {q}_{u} ) \qquad ( 2 )$$

P_{O_PUCCH,b,f,c}(qᵤ) indicates a target reception power, and P_{O_PUCCH,b,f,c}(qᵤ)=P_{O_NOMINAL,PUCCH}+P_{O_UE_PUCCH}(qᵤ), where 0≤qᵤ<Qᵤ.

P_{O_NOMINAL,PUCCH} is configured by a parameter p0-nominal. If the parameter p0-nominal is not provided, P_{O_NOMINAL,PUCCH}=0.

P_{O_UE_PUCCH}(qᵤ) is configured by p0-PUCCH-Value in a parameter P0-PUCCH.

Qᵤ indicates a size for a set of P_{O_UE_PUCCH} values, which is configured by maxNrofPUCCH-P0-PerSet.

The set of P_{O_UE_PUCCH} values is configured by a parameter p0-Set. If the parameter p0-Set is not provided, P_{O_PUCCH,b,f,c}(qᵤ)=0.

$${M}_{RB , b , f , c}^{PUCCH} ( i ) \qquad ( 3 )$$

$${M}_{RB , b , f , c}^{PUCCH} ( i )$$

is a bandwidth of the PUCCH resource assignment, which indicates the number of RBs for PUCCH transmission occasion i on active UL BWP b of carrier f of primary cell c.

$${PL}_{b , f , c} ( {q}_{d} ) \qquad ( 4 )$$

PL_{b,f,c}(q_{d}) indicates a downlink pathloss estimate calculated by the terminal device according to an RS. The RS may be an SSB or a CSI-RS, and an index of the RS is q. A unit of PL_{b,f,c}(q_{d}) is dB.

$${Δ}_{{F}_{-} PUCCH} ( F ) \qquad ( 5 )$$

Δ_{TF_PUCCH}(F) may be a value of deltaF-PUCCH-f0 for a parameter PUCCH format 0, a value of deltaF-PUCCH-f1 for a parameter PUCCH format 1, a value of deltaF-PUCCH-f2 for a parameter PUCCH format 2, and a value of deltaF-PUCCH-f3 for a parameter PUCCH format 3. If these parameters are not provided, Δ_{F_PUCCH}(F)=0.

$${Δ}_{TF , b , f , c} ( i ) \qquad ( 6 )$$

Δ_{TF,b,f,c}(i) indicates a PUCCH power control component.

For a PUCCH transmission using PUCCH format 0 or PUCCH format 1, Δ_{TF,b,f,c}(i) is as follows.

$${Δ}_{TF , b , f , c} ( i ) = 10 {log}_{10} ( \frac{{N}_{ref}^{PUCCH}}{{N}_{symb}^{PUCCH} ( i )} ) + {Δ}_{UCI} ( i )$$

In the above,

$${N}_{symb}^{PUCCH} ( i )$$

indicates wie number of PUCCH format 0 symbols or PUCCH format 1 symbols for the PUCCH transmission. If PUCCH format 0 is used,

$${N}_{ref}^{PUCCH} = 2 ,$$

and if PUCCH format 1 is used,

$${N}_{ref}^{PUCCH} = {N}_{symb}^{slot} .$$

If PUCCH format 0 is used, Δ_{UCI}(i)=0, and if PUCCH format 1 is used, Δ_{UCI}(i)=0, or Δ_{UCI}(i)=10 log₁₀(O_{UCI}(i)), where O_{UCI}(i) is the number of uplink control information (UCI) in PUCCH transmission occasion i.

$${g}_{b , f , c} ( i , l ) \qquad ( 7 )$$

g_{b,f,c}(i,l) indicates a PUCCH power control adjustment state. g_{b,f,c}(i,l) can be calculated according to a TPC command.

In specific implementation, g_{b,f,c}(i,l) can be calculated in a TPC command accumulation manner as follows.

$${g}_{b , f , c} ( i , l ) = {g}_{b , f , c} ( i - {i}_{0} , l ) + {\sum }_{m = 0}^{C ( {C}_{i} ) - 1} {δ}_{PUCCH , b , f , c} ( m , l )$$

In the above, δ_{PUCCH,b,f,c} indicates a value of the TPC command, which can be determined according to accumulated δ_{PUCCH,b,f,c} in Table 2.

$${Σ}_{m = 0}^{C ( {D}_{i} ) - 1} {δ}_{PUCCH , b , f , c} ( m , l )$$

indicates a sum of TPC command values (i.e., accumulation of the TPC command values) in a set Cᵢ, where the set Cᵢ includes C(Cᵢ) TPC command values. C(Cᵢ) TPC command values are obtained by the terminal device between K_{PUCCH}(i−i₀)−1 symbols before PUCCH transmission occasion i−i₀, and K_{PUCCH}(i) symbols before PUCCH transmission occasion i, where i₀>0 is the smallest integer for which K_{PUCCH} (i−i₀) symbols before PUCCH transmission occasion i−i₀ are earlier than K_{PUCCH}(i) symbols before PUCCH transmission occasion i.

TABLE 2

| TPC command | Accumulated δ_{PUCCH, b, f, c} or |
|---|---|
| field | δ_{SRS, b, f, c} [dB] |
| 0 | −1 |
| 1 | 0 |
| 2 | 1 |
| 3 | 3 |

### 3. SRS Transmission

If the terminal device transmits an SRS on active UL BWP b of carrier f of serving cell c using SRS power control adjustment state with index l, the terminal device determines the SRS transmission power P_{SRS,b,f,c}(i, qₛ, l) in SRS transmission occasion i as:

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \}$$

The meanings of parameters will be described in detail below.

$${P}_{CMAX , f , c} ( i ) \qquad ( 1 )$$

P_{CMAX,f,c}(i) indicates the maximum output power configured for the terminal device for carrier f of serving cell c in SRS transmission occasion i.

$${P}_{O\_SRS , b , f , c} ( {q}_{s} ) \qquad ( 2 )$$

P_{O_SRS,b,f,c}(qₛ) indicates a target reception power, which is configured by a parameter p0. qₛ indicates an SRS resource set, which is configured by parameters SRS-ResourceSet and SRS-ResourceSetId.

$${M}_{SRS , b , f , c} ( i ) \qquad ( 3 )$$

M_{SRS,b,f,c}(i) is an SRS bandwidth, which indicates the number of RBs for SRS transmission occasion i on active UL BWP b of carrier f of serving cell c.

$${α}_{SRS , b , f , c} ( {q}_{s} ) \qquad ( 4 )$$

α_{SRS,b,f,c}(qₛ) is configured by a parameter alpha.

$$P {L}_{b , f , c} ( {q}_{d} ) \qquad ( 5 )$$

PL_{b,f,c}(q_{d}) is a downlink pathloss estimate calculated by the terminal device according to an RS. The RS may be an SSB or a CSI-RS, and an index of the RS is q_{d}. A unit of PL_{b,f,c}(q_{d}) is dB.

$${h}_{b , f , c} ( i , l ) \qquad ( 6 )$$

h_{b,f,c}(i,l) indicates an SRS power control adjustment state. h_{b,f,c}(i,l) can be calculated according to a TPC command.

In specific implementation, h_{b,f,c}(i,l) can be calculated in a TPC command accumulation manner as follows.

$${h}_{b , f , c} ( i , l ) = {h}_{b , f , c} ( i - {i}_{0} , l ) + {\sum }_{m = 0}^{C ( {S}_{i} ) - 1} {δ}_{SRS , b , f , c} ( m , l )$$

In the above, δ_{SRS,b,f,c} indicates a value of the TPC command, which can be determined according to accumulated δ_{SRS,b,f,c} in Table 1.

$${Σ}_{m = 0}^{C ( {S}_{i} ) - 1} {δ}_{SRS , b , f , c} ( m , l )$$

indicates a sum of TPC command values (i.e., accumulation of the TPC command values) in a set Sᵢ, where the set Sᵢ includes C(Sᵢ) TPC command values. C(Sᵢ) TPC command values are obtained by the terminal device between K_{SRS}(i−i₀)−1 symbols before SRS transmission occasion i−i₀ and K_{SRS}(i) symbols before SRS transmission occasion i, where i₀>0 is the smallest integer for which K_{SRS} (i−i₀) symbols before SRS transmission occasion i−i₀ are earlier than K_{SRS}(i) symbols before SRS transmission occasion i.

### 4. PRACH Transmission

If the terminal device transmits a PRACH on active UL BWP b of carrier f of serving cell c using SRS power control adjustment state with index l, the terminal device determines the PRACH transmission power P_{PRACH,b,f,c}(i) in PRACH transmission occasion i as:

$${P}_{PRACH , b , f , c} ( i ) = min \{ {P}_{CMAX , f , c} ( i ) , {P}_{PRACH , target , f , c} + P {L}_{b , f , c} \}$$

P_{CMAX,f,c}(i) indicates the maximum output power configured for the terminal device for carrier f of serving cell c in PRACH transmission occasion i. P_{PRACH,target,f,c} indicates a target reception power. PL_{b,f,c} indicates a downlink pathloss estimate calculated by the terminal device according to an RS.

### III. Transmission Mode

It may be noted that in embodiments of the disclosure, various transmission modes are supported, for example, time division duplexing (TDD), frequency division duplexing (FDD), flexible duplex, full duplex, and the like. A time-domain resource location, a frequency-domain resource location, TDD, FDD, flexible duplex, and full duplex will be described below.

### 1. Time-Domain Resource Location and Frequency-Domain Resource Location

In embodiments of the disclosure, the time-domain resource location can be understood as a location of a resource for transmission in the time domain. For example, the time-domain resource location may include one of a subframe, a slot, a symbol, a mini slot, and the like, which is not limited herein.

The frequency-domain resource location can be understood as a location of a resource for transmission in the frequency domain. For example, the frequency-domain resource location may include one of a subband, a RB, a RE, a subcarrier, and the like, which is not limited herein.

It may be noted that, the subband herein can be understood as a subband divided from a bandwidth. The bandwidth may be a BWP.

In some possible implementations, the same time-domain resource location or the same frequency-domain resource location can support only uplink transmission or can support only downlink transmission. In other words, transmission directions on the same time-domain resource location or the same frequency-domain resource location are the same, which need to be determined according to the transmission mode.

In some possible implementations, the same time-domain resource location or the same frequency-domain resource location can support both uplink transmission and downlink transmission. In other words, transmission directions on the same time-domain resource location or the same frequency-domain resource location are different, which need to be determined according to the transmission mode.

### 2. TDD and FDD

It may be noted that for the TDD, in the same frequency-domain resource location, different time-domain resource locations are respectively used for uplink transmission and downlink transmission, and transmission directions on the same time-domain resource location are the same, i.e., cither uplink transmission or downlink transmission.

For example, when the time-domain resource location is a slot, the network configures slot n and slot n+1 to support downlink transmission and configures slot n+2 to support uplink transmission. In this case, downlink communication between the network device and the terminal device can only be performed in slot n and slot n+1, and uplink communication between the network device and the terminal device can only be performed in slot n+2.

For the FDD, in the same time-domain location, different frequency-domain resource locations are respectively used for uplink transmission and downlink transmission, and transmission directions on the same frequency-domain resource location are the same, i.e., either uplink transmission or downlink transmission.

### 3. Flexible Duplex

It may be noted that, the flexible duplex may include flexible TDD and/or flexible FDD. Through the flexible duplex, different transmission requirements can be satisfied, thereby improving flexibility of the transmission mode.

For the flexible TDD, a flexible time-domain resource location and a non-flexible time-domain resource location exist in the same frequency-domain resource location.

The non-flexible time-domain resource location may mean that transmission directions supported by the non-flexible time-domain resource location cannot change dynamically, which is similar to the descriptions in the “TDD” above.

The flexible time-domain resource location may mean that transmission directions supported by the flexible time-domain resource location can change dynamically. In other words, in the same flexible time-domain resource location, the network can schedule/configure a certain cell or a certain terminal device to support downlink transmission, and schedule/configure another cell or another terminal device to support uplink transmission.

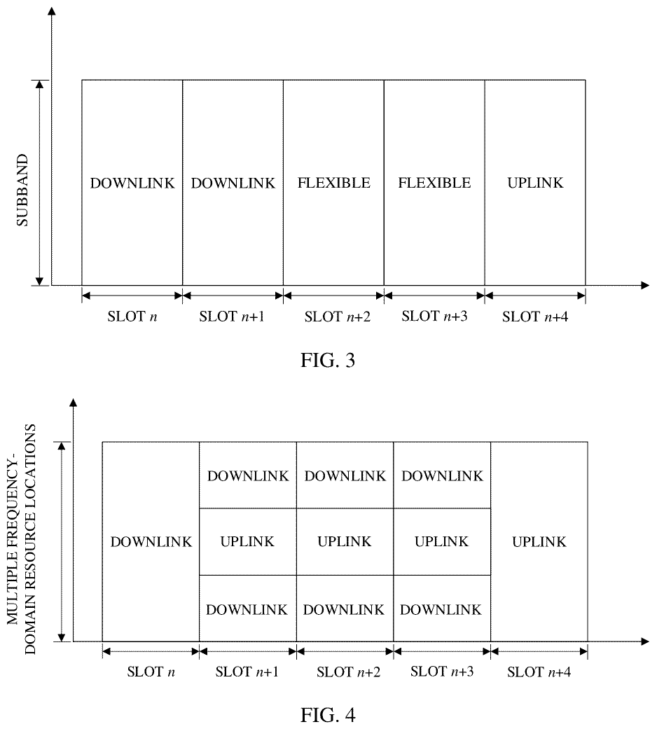

For example, when the time-domain resource location is a slot, as illustrated in FIG. 3, in one or more frequency-domain resource locations, the network configures slot n and slot n+1 to support downlink transmission, configures slot n+4 to support uplink transmission, and configures slot n+2 and slot n+3 to be flexible.

Similarly, for the flexible FDD, a flexible frequency-domain resource location and a non-flexible frequency-domain resource location exist in the same time-domain resource location.

The non-flexible frequency-domain resource location may mean that transmission directions supported by the non-flexible frequency-domain resource location cannot change dynamically, which is similar to the descriptions in the “FDD” above.

The flexible frequency-domain resource location may mean that transmission directions supported by the flexible frequency-domain resource location can change dynamically.

### 4. Full Duplex

It may be noted that, the full duplex may mean that the same time-domain resource location or the same frequency-domain resource location can support both uplink transmission and downlink transmission, or different frequency-domain resource locations in the same time-domain resource location can support uplink transmission and downlink transmission respectively, or different time-domain resource locations in the same frequency-domain resource location can support uplink transmission and downlink transmission respectively.

For example, when the time-domain resource location is a slot, as illustrated in FIG. 4, the network configuration is as follows. Downlink transmission is supported in slot n. Both uplink transmission and downlink transmission are supported in slot n+1, slot n+2, and slot n+3, i.e., frequency-domain resource locations supporting uplink transmission and frequency-domain resource locations supporting downlink transmission exist in slot n+1, slot n+2, and slot n+3. Uplink transmission is supported in slot n+4.

In some possible implementations, the full duplex may include subband non-overlapping full duplex (SBFD).

### IV. Uplink Power Control Enhancement

With increasingly complex and diverse communication scenarios, the transmission may suffer from different types of interference. For example, these types of interference include cross link interference (CLI), inter-subband interference between network devices, intra-subband interference between network devices, self-interference, inter-subband interference between terminal devices, and intra-subband interference between terminal devices. As a result, uplink power control for uplink transmission becomes more complex.

Based on this, from the perspective of multiple uplink resource locations configured/scheduled for uplink transmission, it is considered in embodiments of the disclosure that different types of interference may occur in different uplink resource locations. Then, in embodiments of the disclosure, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

The technical solutions, beneficial effects, concepts, and the like involved in embodiments of the disclosure will be described in detail below.

### 1. Multiple Uplink Resource Locations Configured/Scheduled for Uplink Transmission

### (1) Uplink Transmission

It may be noted that in combination with “II. Uplink power control” above, the uplink transmission may include at least one of: PUSCH transmission, PUCCH transmission, SRS transmission, or PRACH transmission.

In addition, in combination with “III. Transmission mode” above, the uplink transmission can support at least one of TDD, FDD, flexible duplex, full duplex, or the like.

### (2) Uplink Resource Location

It may be noted that, the uplink resource location can be understood as a location of a resource for uplink transmission.

In combination with “1. Time-domain resource location and frequency-domain resource location” above, the uplink resource location may include an uplink time-domain resource location and/or an uplink frequency-domain resource location.

The uplink time-domain resource location can be understood as a time-domain resource location that supports uplink transmission, i.e., a location of a resource for uplink transmission in the time domain.

The uplink frequency-domain resource location can be understood as a frequency-domain resource location that supports uplink transmission, i.e., a location of a resource for uplink transmission in the frequency domain.

In some possible implementations, the uplink time-domain resource location may include one of a subframe, a slot, a symbol, a mini slot, and the like, thereby ensuring flexibility of resource configuration.

In some possible implementations, the uplink frequency-domain resource location may include one of a subband, a RB, a resource block group (RBG), a RE, a subcarrier, and the like, thereby ensuring flexibility of resource configuration.

### (3) Configuring/Scheduling Multiple Uplink Resource Locations for Uplink Transmission

It may be noted that, the network device can configure/schedule for the terminal device the multiple uplink resource locations for the uplink transmission. Accordingly, the terminal device obtains the multiple uplink resource locations configured/scheduled for the uplink transmission. As such, the terminal device can perform uplink transmission in these uplink resource locations.

In specific implementation, the network device can configure/schedule for the terminal device multiple uplink time-domain resource locations and/or multiple uplink frequency-domain resource locations for the uplink transmission.

For example, when the uplink time-domain resource location is a slot, the uplink transmission may be in slot n, slot n+1, slot n+2, slot n+3, and slot n+4. For another example, when the uplink frequency-domain resource location is a subband, the uplink transmission is in subband m, subband m+1, and subband m+2.

In some possible implementations, the multiple uplink time-domain resource locations may be on one or more uplink frequency-domain resource locations.

For example, when the uplink time-domain resource location is a slot and the uplink frequency-domain resource location is a subband, the uplink transmission may be in slot n, slot n+1, slot n+2, slot n+3, and slot n+4. In particular, there are the following configurations manners. One configuration manner is that the uplink transmission in slot n, slot n+1, slot n+2, slot n+3, and slot n+4 is limited to subband m. One configuration manner is that the uplink transmission in slot n, slot n+1, slot n+2, slot n+3, and slot n+4 is limited to subband m+1. One configuration manner is that the uplink transmission in slot n and slot n+1 is limited to subband m and subband m+1, and the uplink transmission in slot n+2 and slot n+3 is limited to subband m+2 and subband m+3; and so on.

In some possible implementations, the multiple uplink frequency-domain resource locations may be in one or more uplink time-domain resource locations.

For example, when the uplink time-domain resource location is a slot and the uplink frequency-domain resource location is a subband, the uplink transmission may be in subband m, subband m+1, subband m+2, and subband m+3. In particular, there are the following configurations manners. One configuration manner is that the uplink transmission in subband m, subband m+1, subband m+2, and subband m+3 is limited to slot n. One configuration manner is that the uplink transmission in subband m, subband m+1, subband m+2, and subband m+3 is limited to slot n and slot n+1. One configuration manner is that the uplink transmission in subband m and subband m+1 is limited to slot n, and the uplink transmission in subband m+2 and subband m+3 is limited to slot n+1; and so on.

In some possible implementations, the multiple uplink resource locations can be scheduled/configured through dynamic scheduling or configured grant.

As can be seen, configuration/scheduling of the multiple uplink resource locations is realized through dynamic scheduling or configured grant.

### (4) Location Indication of the Uplink Resource Location

It may be noted that during configuration/scheduling of the uplink resource locations by the network device, the network device can indicate, via location indication, each uplink resource location and/or an uplink power control parameter set to which each uplink resource location belongs. In other words, the location indication may indicate an uplink resource location and/or a belonging relationship between the uplink resource location and the uplink power control parameter set, which will be described in detail below.

In some possible implementations, the location indication may include Type-1 location indication and/or Type-2 location indication.

The Type-1 location indication may indicate an index/identity (ID)/number of the uplink resource location. Therefore, the uplink resource locations are distinguished based on different values of the Type-1 location indication.

The Type-2 location indication may indicate a belonging relationship/association relationship/correspondence between the uplink resource location and the uplink power control parameter set. Therefore, an uplink power control parameter set to which one or more uplink resource locations belong can be known via the Type-2 location indication.

In some possible implementations, the Type-1 location indication may include time-domain location indication and/or frequency-domain location indication. The time-domain location indication may indicate an uplink time-domain resource location, and the frequency-domain location indication may indicate an uplink frequency-domain resource location.

Specifically, the time-domain location indication may indicate an index/ID/number of a time-domain location of an uplink time-domain resource. As such, which uplink time-domain resources are used for uplink transmission can be determined according to an index, etc.

For example, when the uplink time-domain resource location is a slot, the time-domain location indication may indicate that an index of the slot is n, so that it is known via the time-domain location indication that uplink transmission is performed in slot n.

Specifically, the frequency-domain location indication may indicate a frequency-domain starting location of an uplink frequency-domain resource and a length/size of the uplink frequency-domain resource. As such, which uplink frequency-domain resources are used for uplink transmission can be determined according to an index, etc.

For example, when the uplink frequency-domain resource location is a RB, the frequency-domain location indication may indicate that a frequency-domain starting location is RB 0 and a length is 20 RBs, so that it is known via the frequency-domain location indication that uplink transmission is performed in the 20 RBs from RB 0 to RB 19.

Specifically, the frequency-domain location indication may include a resource indication value (RIV). As such, which uplink frequency-domain resources are used for uplink transmission can be determined according to the RIV.

### 2. Uplink Power Control Parameter Set

### (1) Description

It may be noted that in order to realize the uplink power control, the uplink power control parameter set is introduced in embodiment of the disclosure. The uplink power control parameter set can be used to configure parameters and/or TPC commands in an uplink power control process, so that the uplink power control can be realized based on these parameters and/or TPC commands. Certainly, the uplink power control parameter set can also be described in other terms, which is not limited herein.

### (2) Uplink Power Control Parameter Set to which the Uplink Resource Location Belongs

In embodiments of the disclosure, the uplink power control parameter set to which the uplink resource location belongs may mean that an uplink resource location may belong to/have/be associated with/correspond to an uplink power control parameter set.

It may be noted that among the multiple uplink resource locations configured/scheduled by the network device for the uplink transmission, the network device configures for each uplink resource location an uplink power control parameter set to which the uplink resource location belongs. Independent uplink power control is used for each of uplink resource locations belonging to different uplink power control parameter sets.

As such, the terminal device can determine, according to the uplink power control parameter set to which the uplink resource location belongs, uplink power control to be used by the terminal device.

In some possible implementations, among the multiple uplink resource locations, uplink resource locations belonging to the same uplink power control parameter set are configured.

It may be understood that among the multiple uplink resource locations configured for the uplink transmission, some uplink resource locations may be configured to belong to a certain uplink power control parameter set, and other uplink resource locations may be configured to belong to another uplink power control parameter set.

As such, parameters and/or TPC commands in the same uplink power control parameter set can be used for the uplink resource locations belonging to the same uplink power control parameter set, thereby realizing the same uplink power control.

For example, when the uplink time-domain resource location is a slot, the uplink transmission is in slot n, slot n+1, slot n+2, slot n+3, and slot n+4. Slot n and slot n+1 belong to one uplink power control parameter set, and slot n+3 and slot n+4 belong to another uplink power control parameter set.

### (3) Index of the Uplink Power Control Parameter Set

It may be noted that, the network device can configure multiple uplink power control parameter sets, some uplink resource locations belong to a certain uplink power control parameter set, and other uplink resource locations belong to another uplink power control parameter set. Therefore, in order to distinguish the uplink power control parameter sets, an index/ID/number k of the uplink power control parameter set is introduced in embodiment of the disclosure.

In this regard, the uplink power control parameter sets can be distinguished based on different values of index k.

### (4) how to Configure the Belonging Relationship Between the Uplink Resource Location and the Uplink Power Control Parameter Set

In embodiments of the disclosure, the belonging relationship/association relationship/correspondence between the uplink resource location and the uplink power control parameter set can be configured by a higher-layer parameter/higher-layer information/higher-layer signaling.

For example, for the uplink transmission, the network device configures through the higher-layer signaling the terminal device with multiple uplink resource locations, and configures through the higher-layer information the terminal device with an uplink power control parameter set to which each of the uplink resource locations belongs.

For example, the higher-layer parameter/higher-layer information/higher-layer signaling includes location indication or a bitmap, based on which how to configure via the location indication or bitmap the uplink resource locations belonging to the same uplink power control parameter set will be described below.

### a) Location Indication

It may be noted that in combination with “(4) Location indication of the uplink resource location” above, for uplink resource locations belonging to the same uplink power control parameter set, the uplink resource locations belonging to the same uplink power control parameter set can be configured via the location indication in embodiment of the disclosure, which is easy to implement.

In addition, since the uplink power control parameter set has index k, the location indication may indicate index k.

For example, when the uplink time-domain resource location is a slot, the network device indicates via the location indication that slot n and slot n+1 belongs to one uplink power control parameter set (k=0), and slot n+3 and slot n+4 belong to another uplink power control parameter set (k=1).

For another example, when the uplink frequency-domain resource location is a RB, the network device indicates via the location indication that RBs with a frequency-domain starting location of RB 0 and a length of 10 RBs belong to one uplink power control parameter set (k=0), and RBs with a frequency-domain starting location of RB 10 and a length of 10 RBs belong to another uplink power control parameter set (k=1).

### b) Bitmap

### \textcircled{1} Description

It may be noted that for uplink resource locations belong to the same uplink power control parameter set, in embodiments of the disclosure, the bitmap is introduced, and the uplink resource locations belonging to the same uplink power control parameter set are configured via the bitmap, which is easy to implement. Bits in the bitmap correspond to the uplink resource locations, and one bitmap corresponds to/is associated with one uplink power control parameter set.

### \textcircled{2} Index of the Bitmap

It may be noted that in order to distinguish bitmaps, an index/ID/number of the bitmap is introduced in embodiments of the disclosure. In this regard, the bitmaps can be distinguished based on different values of indexes of the bitmaps.

### \textcircled{3} Correspondence Between the Bitmap and the Uplink Power Control Parameter Set

In some possible implementations, the correspondence/association relationship between the bitmap and the uplink power control parameter set can be based on network configuration, pre-configuration, or a specification in a protocol, etc.

Taking network configuration as an example, the network device can configure the correspondence between the bitmap and the uplink power control parameter set for the terminal device through the higher-layer signaling/higher-layer parameter/higher-layer information.

In addition, since the uplink power control parameter set has index k, the index of the bitmap may correspond to/be associated with index k, and the correspondence/association relationship can be based on network configuration, pre-configuration, or a specification in a protocol, etc.

### \textcircled{4} Type of the Bitmap

In embodiments of the disclosure, the type of the bitmap may include a bitmap at a time-domain level, a bitmap at a frequency-domain level, and a bitmap at a time-frequency-domain level.

Bits in the bitmap at the time-domain level may correspond to the uplink time-domain resource locations. Bits in the bitmap at the frequency-domain level may correspond to the uplink frequency-domain resource locations. Bits in the bitmap at the time-frequency-domain level may correspond to the uplink time-domain resource locations and the uplink frequency-domain resource locations.

### \textcircled{5} The Bits in the Bitmap Correspond to the Uplink Resource Locations

In embodiments of the disclosure, the bits in the bitmap may correspond to the uplink resource locations as follows. One bit in the bitmap corresponds to one or more uplink resource locations.

In some possible implementations, one bit may correspond to one uplink resource location as follows. One bit corresponds to one uplink time-domain resource location. Alternatively, one bit corresponds to one uplink frequency-domain resource location. Alternatively, one bit corresponds to one uplink time-domain resource location and one uplink frequency-domain resource location.

For example, when the uplink time-domain resource location is a slot and the uplink transmission is PUSCH transmission, the network device configures four slots and a bitmap for the PUSCH transmission. If one bit in the bitmap corresponds to one slot, the first bit corresponds to the first slot, the second bit corresponds to the second slot, and the same applies to the others. If one bit in the bitmap corresponds to two slots, the first bit corresponds to the first slot and the second slot, and the second bit corresponds to the third slot and the fourth slot, and so on.

In some possible implementations, one bit may correspond to multiple uplink resource locations as follows. One bit corresponds to multiple uplink time-domain resource locations. Alternatively, one bit corresponds to multiple uplink frequency-domain resource locations. Alternatively, one bit corresponds to one uplink time-domain resource location and multiple uplink frequency-domain resource locations. Alternatively, one bit corresponds to multiple uplink time-domain resource locations and one uplink frequency-domain resource location.

### \textcircled{6} Length of the Bitmap (i.e., the Total Number of Bits)

In some possible implementations, if one bit in the bitmap corresponds to one uplink time-domain resource location, the length of the bitmap can be determined according to the total duration of uplink resources or the total number of uplink time-domain resource locations configured for uplink transmission.

For example, when the uplink time-domain resource location is a slot, the uplink transmission is in slot n, slot n+1, slot n+2, and slot n+3. Therefore, the length of the bitmap may be 4, and the first bit in the bitmap corresponds to slot n, the second bit corresponds to slot n+1, the third bit corresponds to slot n+2, and the fourth bit corresponds to slot n+3.

In some possible implementations, if one bit in the bitmap corresponds to one uplink frequency-domain resource location, the length of the bitmap can be determined according to the total bandwidth (e.g., UL BWP) of uplink resources or the total number of uplink frequency-domain resource locations configured for uplink transmission.

For example, when the uplink frequency-domain resource location is a subband, the uplink transmission is in subband m, subband m+1, subband m+2, and subband m+3. Therefore, the length of the bitmap may be 4, and the first bit in the bitmap corresponds to subband m, the second bit corresponds to subband m+1, the third bit corresponds to subband m+2, and the fourth bit corresponds to subband m+3.

### \textcircled{7} How to Configure Via the Bitmap the Uplink Resource Locations Belonging to the Same Uplink Power Control Parameter Set

In some possible implementations, if a bit in a bitmap is “1”, an uplink resource location corresponding to the bit belongs to an uplink power control parameter set corresponding to the bitmap.

For example, when the uplink time-domain resource location is a slot, the uplink transmission is in slot n, slot n+1, slot n+2, and slot n+3. In addition, the network device configures three uplink power control parameter sets, each of which corresponds to one bitmap. That is, the first uplink power control parameter set corresponds to the first bitmap, and the same applies to the others. When the network device configures a value of the first bitmap to be “1100”, slot n and slot n+1 belong to the first uplink power control parameter set.

In some possible implementations, if a bit in a bitmap is “0”, an uplink resource location corresponding to the bit belongs to an uplink power control parameter set corresponding to the bitmap.

### (5) Determining, According to an Interference Type to which an Uplink Resource Location Belongs, an Uplink Power Control Parameter Set to which the Uplink Resource Location Belongs

In embodiments of the disclosure, the uplink power control parameter set to which the uplink resource location belongs can be determined according to the interference type that the uplink resource location belongs to/has/is associated with/corresponds to.

It may be noted that, the network device can configure/schedule for the terminal device the multiple uplink resource locations for the uplink transmission. In addition, since the network device can determine which uplink resource locations belong to which interference types, the network device can configure for the terminal device an uplink power control parameter set to which each uplink resource location belongs. As such, the terminal device can determine, according to the uplink power control parameter set, uplink power control to be used for the uplink resource location.

In some possible implementations, the network device can determine, according to UE report information or network-device self-assessment, the interference type to which the uplink resource location belongs.

For example, taking the UE report information as an example, the terminal device can report to the network device at least one of UE assistant information (UAI), power headroom report (PHR), CSI report, or the like.

### (6) how to Determine Uplink Power Control to be Independently Used for Each of the Multiple Uplink Resource Locations

It may be noted that in combination with the above contents, in embodiments of the disclosure, the uplink power control to be independently used for each of the multiple uplink resource locations can be determined according to network configuration, pre-configuration, or a specification in a protocol, etc.

For example, in combination with “a) Location indication” above, the network device configures multiple uplink resource locations for uplink transmission and configures location indication of each uplink resource location. In this way, the terminal device can determine according to location indication of an uplink resource location an uplink power control parameter set to which the uplink resource location belongs, and thus determine, according to the uplink power control parameter set, uplink power control to be independently used for the uplink resource location.

For another example, in combination with “b) Bitmap” above, the network device configures multiple uplink resource locations for uplink transmission and configures a bitmap of the uplink resource location. In this way, the terminal device can determine according to a bitmap of an uplink resource location an uplink power control parameter set to which the uplink resource location belongs, and thus determine, according to the uplink power control parameter set, uplink power control to be independently used for the uplink resource location.

As can be seen, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

### (7) Type of Information Included in the Uplink Power Control Parameter Set

In embodiments of the disclosure, in combination with “II. Uplink power control” above, an uplink transmission power may involve various parameters. Therefore, the uplink power control parameter set in embodiments of the disclosure may include at least one of: a maximum output power, a parameter set configuration, an MCS power adjustment, a power control adjustment state, a TPC command, or the like. Details are hereinafter described separately.

### a) Maximum Output Power

It may be noted that, the maximum output power herein may be the same as maximum output power P_{CMAX,f,c}(i) in “II. Uplink power control” above.

Transmission occasion i in “II. Uplink power control” can be regarded as an uplink resource location, and an uplink power control parameter set to which the uplink resource location belongs includes a maximum output power.

As such, in combination with “(6) How to determine uplink power control to be independently used for each of the multiple uplink resource locations” above, the terminal device can determine, according to location indication of an uplink resource location or according to a bitmap of an uplink resource location, an uplink power control parameter set to which the uplink resource location belongs, determine a maximum output power according to the uplink power control parameter set, and determine an uplink transmission power according to the maximum output power, thereby realizing uplink power control based on the uplink transmission power.

In some possible implementations, the same uplink power control parameter set (i.e., the same value of index k) may include one or more maximum output powers. In embodiments of the disclosure, which maximum output power to use can be determined according to network configuration (such as higher-layer information/higher-layer parameter/higher-layer signaling).

### b) Parameter Set Configuration

In embodiments of the disclosure, the parameter set configuration may include a target reception power and/or a pathloss compensation factor.

It may be noted that, the target reception power herein may be the same as the target reception power in “II. Uplink power control” above.

For example, in the PUSCH transmission, the target reception power herein may be the same as P_{O_PUSCH,b,f,c}(j). In the PUCCH transmission, the target reception power herein may be the same as P_{O_PUCCH,b,f,c}(qᵤ). In the SRS transmission, the target reception power herein may be the same as P_{O_SRS,b,f,c}(qₛ). In the PRACH transmission, the target reception power herein may be the same as P_{PRACH,target,f,c}.

The pathloss compensation factor herein may be the same as the pathloss compensation factor in “II. Uplink power control” above.

For example, in the PUSCH transmission, the pathloss compensation factor herein may be the same as α_{b,f,c}(j). In the SRS transmission, the pathloss compensation factor herein may be the same as α_{SRS,b,f,c}(qₛ).

In addition, transmission occasion i in “II. Uplink power control” can be regarded as an uplink resource location, and an uplink power control parameter set to which the uplink resource location belongs includes a target reception power and/or a pathloss compensation factor.

As such, in combination with “(6) How to determine uplink power control to be independently used for each of the multiple uplink resource locations” above, the terminal device can determine, according to location indication of an uplink resource location or according to a bitmap of an uplink resource location, an uplink power control parameter set to which the uplink resource location belongs, determine a target reception power and/or a pathloss compensation factor according to the uplink power control parameter set, and determine an uplink transmission power according to the target reception power and/or the pathloss compensation factor, thereby realizing uplink power control based on the uplink transmission power.

Taking the PUSCH transmission as an example, the terminal device determines the uplink transmission power as P_{PUSCH,k,b,f,c}(i, j, q_{d}, l).

$${P}_{PUSCH , k , b , f , c} ( i , j , {q}_{d} , l ) = \{ \begin{matrix}{P}_{CMAX , k , f , c} ( i ) , \\ {P}_{O\_PUSCH , k , b , f , c} ( j ) + 10 {log}_{10} ( {2}^{μ} \cdot {M}_{RB , k , b , f , c}^{PUSCH} ( i ) ) + {α}_{k , b , f , c} ( j ) \cdot {PL}_{k , b , f , c} ( {q}_{d} ) + {Δ}_{TF , k , b , f , c} ( i ) + {f}_{k , b , f , c} ( i , l )\end{matrix} \}$$

In some possible implementations, the same uplink power control parameter set (i.e., the same value of index k) may include one or more parameter set configurations. In embodiments of the disclosure, which parameter set configuration to use can be determined according to network configuration (such as higher-layer information/higher-layer parameter/higher-layer signaling).

### c) MCS Power Adjustment

In embodiments of the disclosure, the uplink power control parameter set may include an MCS power adjustment.

It may be noted that, the MCS power adjustment herein may be the same as the MCS power adjustment in “II. Uplink power control” above.

For example, in the PUSCH transmission, the MCS power adjustment herein may be the same as Δ_{TF,b,f,c}(i). In the PUCCH transmission, the MCS power adjustment herein may be the same as Δ_{TF,b,f,c}(i)).

In addition, transmission occasion i in “II. Uplink power control” can be regarded as an uplink resource location, and an uplink power control parameter set to which the uplink resource location belongs includes an MCS power adjustment.

As such, in combination with “(6) How to determine uplink power control to be independently used for each of the multiple uplink resource locations” above, the terminal device can determine, according to location indication of an uplink resource location or according to a bitmap of an uplink resource location, an uplink power control parameter set to which the uplink resource location belongs, determine an MCS power adjustment according to the uplink power control parameter set, and determine an uplink transmission power according to the MCS power adjustment, thereby realizing uplink power control based on the uplink transmission power.

In some possible implementations, the same uplink power control parameter set (i.e., the same value of index k) may include one or more MCS power adjustments. In embodiments of the disclosure, which MCS power adjustment to use can be determined according to network configuration (such as higher-layer information/higher-layer parameter/higher-layer signaling).

### d) Power Control Adjustment State

\textcircled{1} Description

It may be noted that, the power control adjustment state herein may be the same as the power control adjustment state in “II. Uplink power control” above.

For example, in the PUSCH transmission, the power control adjustment state herein may be the same as f_{b,f,c}(i,l). In the PUCCH transmission, the power control adjustment state herein may be the same as g_{b,f,c}(i,l). In the SRS transmission, the power control adjustment state herein may be the same as h_{b,f,c}(i,l).

In addition, transmission occasion i in “II. Uplink power control” can be regarded as an uplink resource location, and an uplink power control parameter set to which the uplink resource location belongs includes a power control adjustment state.

As such, in combination with “(6) How to determine uplink power control to be independently used for each of the multiple uplink resource locations” above, the terminal device can determine, according to location indication of an uplink resource location or according to a bitmap of an uplink resource location, an uplink power control parameter set to which the uplink resource location belongs, determine a power control adjustment state according to the uplink power control parameter set, and determine an uplink transmission power according to the power control adjustment state, thereby realizing uplink power control based on the uplink transmission power.

In some possible implementations, the same uplink power control parameter set (i.e., the same value of index k) may include one or more power control adjustment states. In embodiments of the disclosure, which power control adjustment state to use can be determined according to network configuration (such as higher-layer information/higher-layer parameter/higher-layer signaling).

### \textcircled{2} Calculation of Power Control Adjustment State

It may be noted that in combination with “II. Uplink power control” above, the power control adjustment state herein can be calculated according to a TPC command in an uplink power control parameter set. The TPC command herein may be the same as the TPC command in “II. Uplink power control” above.

For example, in the PUSCH transmission, the TPC command herein may be the same as δ_{PUSCH,b,f,c}. In the PUCCH transmission, the TPC command herein may be the same as δ_{PUCCH,b,f,c}. In the SRS transmission, the TPC command herein may be the same as δ_{SRS,b,f,c}.

In specific implementation, the power control adjustment state herein can be calculated in a TPC command accumulation manner, or can be calculated in a TPC command absolute-value manner, which is determined according to network configuration.

In some possible implementations, if the power control adjustment state is calculated in the TPC command accumulation manner, only TPC commands obtained in uplink resource locations belonging to the same uplink power control parameter set are accumulated in the TPC command accumulation manner, thereby ensuring accuracy.

It may be noted that in combination with “c) Calculation of f_{b,f,c}(i,l)” above, when f_{b,f,c}(i,l) is calculated in the TPC command accumulation manner, C(Dᵢ) TPC command values are obtained by the terminal device between K_{PUSCH}(i−i₀)−1 symbols before PUSCH transmission occasion i−i₀ and K_{PUSCH}(i) symbols before PUSCH transmission occasion i,

PUSCH transmission occasion i can be regarded as an uplink resource location, some uplink resource locations may belong to a certain uplink power control parameter set, and other uplink resource locations may belong to another uplink power control parameter set. Therefore, in embodiments of the disclosure, in terms of obtaining TPC commands, it needs to be ensured that uplink resource locations belong to the same uplink power control parameter set, TPC commands are obtained in uplink resource locations belonging to the same uplink power control parameter set, and then these TPC commands are accumulated, so as to obtain a power control adjustment state.

Taking the PUCSH transmission as an example, f_{b,f,c}(i,l) is calculated in the TPC command accumulation manner as follows.

$${f}_{k , b , f , c} ( i , l ) = {f}_{k , b , f , c} ( i - {i}_{0} , l ) + {\sum }_{m = 0}^{C ( {D}_{k , i} ) - 1} {δ}_{PUSCH , k , b , f , c} ( m , l )$$

In the above, δ_{PUSCH,k,b,f,c} indicates a value of the TPC command.

$${Σ}_{m = 0}^{C ( {D}_{k , i} ) - 1} {δ}_{PUSCH , k , b , f , c} ( m , l )$$

indicates a sum of TPC command values (i.e., accumulation of the TPC command values) in a set D_{k,i}, where the set D_{k,i} includes C (D_{k,i}) TPC command values for the same index l. C (D_{k,i}) TPC command values are obtained by the terminal device between symbols belonging to uplink power control parameter set k among K_{PUSCH}(i−i₀)−1 symbols before PUSCH transmission occasion i−i₀ and symbols belonging to uplink power control parameter set k among K_{PUSCH}(i) symbols before PUSCH transmission occasion i, where i₀>0 is the smallest integer for which K_{PUSCH}(i−i₀) symbols before PUSCH transmission occasion i−i₀ are earlier than K_{PUSCH}(i) symbols before PUSCH transmission occasion i.

### 3. Exemplary Description of an Uplink Power Control Method

### 1) Description

In combination with the above contents, an example of an uplink power control method in embodiments of the disclosure is introduced below. It may be noted that, the network device may be a chip, a chip module, or a communication module, etc., and the terminal device may be a chip, a chip module, or a communication module, etc. In other words, the method is applied to the network device or the terminal device, which is not limited herein.

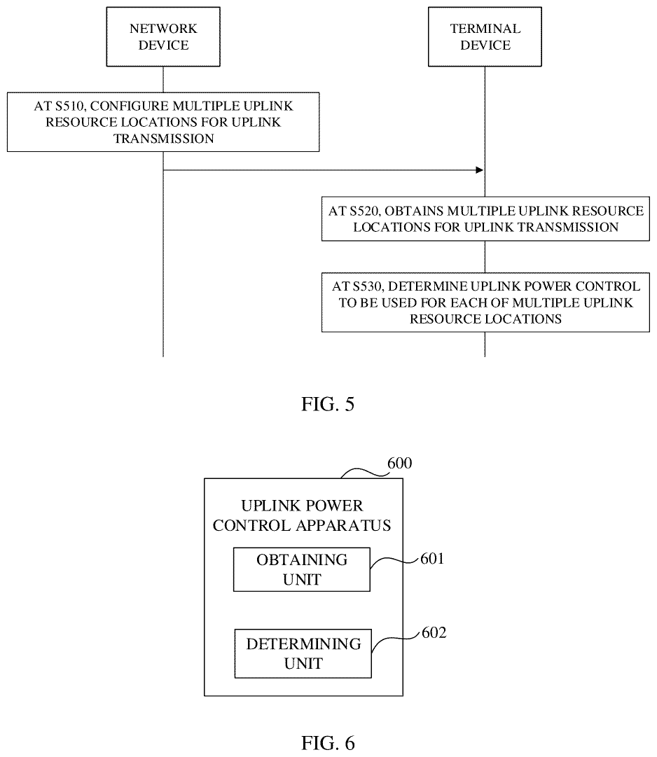

FIG. 5 is a schematic flowchart of an uplink power control method according to embodiments of the disclosure. Specifically, the method includes the following.

At S510, a network device configures multiple uplink resource locations for uplink transmission.

Uplink power control is used for each of the multiple uplink resource locations.

At S520, a terminal device obtains multiple uplink resource locations for uplink transmission.

At S530, the terminal device determines uplink power control to be used for each of the multiple uplink resource locations.

It may be noted that, for details of “uplink resource location” and “uplink power control”, etc., reference can be made to the above, which will not be repeated herein.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

### 2) Some Possible Implementations

In combination with the above contents, some possible implementations will be described below, and for others that are not described, reference can be made to the above, which will not be repeated herein.

In some possible implementations, the uplink transmission supports at least one of TDD, FDD, flexible duplex, or full duplex.

In some possible implementations, for each of the multiple uplink resource locations, an interference type to which the uplink resource location belongs is determined.

It may be noted that in combination with “(5) Determining, according to an interference type to which an uplink resource location belongs, an uplink power control parameter set to which the uplink resource location belongs” above, an interference type to which an uplink resource location belongs is determined for the uplink resource location. As such, an uplink power control parameter set to which the uplink resource location belongs is determined according to the interference type to which the uplink resource location belongs, thereby realizing uplink power control based on the uplink power control parameter set.

In some possible implementations, the interference type to which the uplink resource location belongs can be determined according to UE report information or network-device self-assessment, etc.

It may be noted that in combination with “(5) Determining, according to an interference type to which an uplink resource location belongs, an uplink power control parameter set to which the uplink resource location belongs” above, the interference type to which the uplink resource location belongs can be determined in flexible manners in embodiments of the disclosure.

In some possible implementations, among the multiple uplink resource locations, each uplink resource location is configured with an uplink power control parameter set to which the uplink resource location belongs. The uplink power control parameter set is used to configure a parameter and/or a TPC command in an uplink power control process. Independent uplink power control is used for each of uplink resource locations belonging to different uplink power control parameter sets.

It may be noted that in combination with “(2) Uplink power control parameter set to which the uplink resource location belongs” above, among the multiple uplink resource locations configured/scheduled by the network device for the uplink transmission, the network device configures for each uplink resource location an uplink power control parameter set to which the uplink resource location belongs. Independent uplink power control is used for each of uplink resource locations belonging to different uplink power control parameter sets.

As such, the terminal device can determine, according to the uplink power control parameter set to which the uplink resource location belongs, uplink power control to be used by the terminal device.

In some possible implementations, the uplink power control parameter set to which the uplink resource location belongs can be determined according to an interference type that the uplink resource location belongs to/has/is associated with/corresponds to.

It may be noted that in combination with “(5) Determining, according to an interference type to which an uplink resource location belongs, an uplink power control parameter set to which the uplink resource location belongs” above, the network device can configure/schedule for the terminal device the multiple uplink resource locations for the uplink transmission. In addition, since the network device can determine which uplink resource locations belong to which interference types, the network device can configure for the terminal device an uplink power control parameter set to which each uplink resource location belongs. As such, the terminal device can determine, according to the uplink power control parameter set, uplink power control to be used for the uplink resource location.

In some possible implementations, among the multiple uplink resource locations, uplink resource locations belonging to the same uplink power control parameter set are configured.

It may be noted that in combination with “(2) Uplink power control parameter set to which the uplink resource location belongs” above, among the multiple uplink resource locations configured for the uplink transmission, some uplink resource locations may be configured to belong to a certain uplink power control parameter set, and other uplink resource locations may be configured to belong to another uplink power control parameter set.

As such, parameters and/or TPC commands in the same uplink power control parameter set can be used for the uplink resource locations belonging to the same uplink power control parameter set, thereby realizing the same uplink power control.

In some possible implementations, uplink resource locations belonging to the same uplink power control parameter set are configured via location indication, and the location indication includes Type-1 location indication and/or Type-2 location indication. The Type-1 location indication indicates an index of an uplink resource location, and the Type-2 location indication indicates a belonging relationship between the uplink resource location and the uplink power control parameter set.

It may be noted that in combination with “(4) How to configure the belonging relationship between the uplink resource location and the uplink power control parameter set” above, for uplink resource locations belonging to the same uplink power control parameter set, the uplink resource locations belonging to the same uplink power control parameter set can be configured via the location indication in embodiment of the disclosure, which is easy to implement.

In some possible implementations, uplink resource locations belonging to the same uplink power control parameter set are configured via a bitmap, and bits in the bitmap correspond to the uplink resource locations.

It may be noted that in combination with “(4) How to configure the belonging relationship between the uplink resource location and the uplink power control parameter set” above, for uplink resource locations belong to the same uplink power control parameter set, in embodiments of the disclosure, the bitmap is introduced, and the uplink resource locations belonging to the same uplink power control parameter set are configured via the bitmap, which is easy to implement.

In some possible implementations, the uplink power control to be used for each of the multiple uplink resource locations is determined at S530 as follows. The terminal device determines, according to location indication of the uplink resource location or according to a bitmap of the uplink resource location, an uplink power control parameter set to which the uplink resource location belongs. The terminal device determines, according to the uplink power control parameter set, the uplink power control to be used for the uplink resource location.

It may be noted that in combination with “(6) How to determine uplink power control to be independently used for each of the multiple uplink resource locations” above, the terminal device can determine, according to location indication of an uplink resource location or according to a bitmap of an uplink resource location, an uplink power control parameter set to which the uplink resource location belongs, and thus determine, according to the uplink power control parameter set, uplink power control to be independently used for the uplink resource location.

Accordingly, the uplink power control to be independently used for the uplink resource location may be determined as follows. An uplink power control parameter set to which the uplink resource location belongs is determined according to location indication of the uplink resource location or according to a bitmap of the uplink resource location. The uplink power control to be independently used for the uplink resource location is determined according to the uplink power control parameter set.

In some possible implementations, the same uplink power control parameter set may include one or more parameter set configurations, and the parameter set configuration includes a received target power spectrum and/or a pathloss compensation factor.

It may be noted that in combination with “b) Parameter set configuration” above, in embodiments of the disclosure, which parameter set configuration to use can be determined according to network configuration (such as higher-layer information/higher-layer parameter/higher-layer signaling).

In some possible implementations, the same uplink power control parameter set may include one or more MCS power adjustments.

It may be noted that in combination with “c) MCS power adjustment” above, in embodiments of the disclosure, which MCS power adjustment to use can be determined according to network configuration (such as higher-layer information/higher-layer parameter/higher-layer signaling).

In some possible implementations, the same uplink power control parameter set may include one or more power control adjustment states.

It may be noted that in combination with “d) Power control adjustment state” above, in embodiments of the disclosure, which power control adjustment state to use can be determined according to network configuration (such as higher-layer information/higher-layer parameter/higher-layer signaling).

In some possible implementations, the power control adjustment state is calculated in a TPC command accumulation manner, and in the TPC command accumulation manner, only TPC commands obtained in uplink resource locations belonging to the same uplink power control parameter set are accumulated.

It may be noted that in combination with “d) Power control adjustment state” above, if the power control adjustment state is calculated in the TPC command accumulation manner, only the TPC commands obtained in the uplink resource locations belonging to the same uplink power control parameter set are accumulated in the TPC command accumulation manner, thereby ensuring accuracy.

In some possible implementations, the uplink resource location may include an uplink time-domain resource location and/or an uplink frequency-domain resource location. The uplink time-domain resource location may include one of a subframe, a slot, a symbol, and a mini slot. The uplink frequency-domain resource location may include one of a subband, a subcarrier, a RB, and a RE.

It may be noted that in combination with “(2) Uplink resource location” above, uplink resource locations can be configured according to respective resource types, thereby ensuring flexibility of resource configuration.

### V. Exemplary Description of an Uplink Power Control Apparatus

### 1. Description

The solutions in embodiments of the disclosure are introduced mainly from the perspective of the method. It may be understood that, in order to realize the foregoing functions, the terminal device or the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods may not be regarded as lying beyond the scope of the disclosure.

In embodiments of the disclosure, division of functional units of the terminal device or the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It may be noted that, the division of units in embodiments of the disclosure is illustrative and is only a division of logical functions, and other methods of division may also available in practice.

If an integrated unit is used, FIG. 6 is a block diagram illustrating functional units of an uplink power control apparatus according to embodiments of the disclosure. The uplink power control apparatus 600 includes an obtaining unit 601 and a determining unit 602.

In some possible implementations, the obtaining unit 601 may be a module or unit configured to process signals, data, information, etc., which is not limited herein.

In some possible implementations, the determining unit 602 may be a module or unit configured to process signals, data, information, etc., which is not limited herein.

In some possible implementations, the uplink power control apparatus 600 may further include a storage unit configured to store computer program codes or instructions executed by the uplink power control apparatus 600. The storage unit may be a memory.

In some possible implementations, the uplink power control apparatus 600 may be a chip or a chip module.

In some possible implementations, the obtaining unit 601 and the determining unit 602 may be integrated into the same unit, or each may be integrated into different units. For example, the obtaining unit 601 may be integrated in a communication unit, and the determining unit 602 may be integrated into a processing unit.

For another example, the obtaining unit 601 and the determining unit 602 may be integrated into a processing unit.

It may be noted that, the communication unit may be a communication interface, a transceiver, a transceiver circuit, or the like.

The processing unit may be a processor or a controller, such as a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the obtaining unit 601 and the determining unit 602 are configured to perform any operation performed by the terminal device/chip/chip module, etc. in above method embodiments, such as transmitting or receiving data, etc., which will be described in detail below.

In specific implementation, the obtaining unit 601 and the determining unit 602 are configured to perform any operation in above method embodiments, and when executing actions such as transmitting, other units can be selectively invoked to complete corresponding operations, which will be described in detail below.

The obtaining unit 601 is configured to obtain multiple uplink resource locations configured for uplink transmission. The determining unit 602 is configured to determine uplink power control to be used for each of the multiple uplink resource locations.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

It may be noted that, for the implementation of various operations in the embodiments illustrated in FIG. 6, reference can be made to the elaborations in the method embodiments above, which will not be repeated herein.

### 2. Some Possible Implementations

Some possible implementations will be described below. For some specific descriptions, reference can be made to the elaborations above, which will not be repeated herein.

In some possible implementations, among the multiple uplink resource locations, each uplink resource location is configured with an uplink power control parameter set to which the uplink resource location belongs. The uplink power control parameter set is used to configure a parameter and/or a TPC command in an uplink power control process. Independent uplink power control is used for each of uplink resource locations belonging to different uplink power control parameter sets.

In some possible implementations, among the multiple uplink resource locations, uplink resource locations belonging to the same uplink power control parameter set are configured.

In some possible implementations, uplink resource locations belonging to the same uplink power control parameter set are configured via location indication, and the location indication includes Type-1 location indication and/or Type-2 location indication. The Type-1 location indication indicates an index of an uplink resource location, and the Type-2 location indication indicates a belonging relationship between the uplink resource location and the uplink power control parameter set.

In some possible implementations, uplink resource locations belonging to the same uplink power control parameter set are configured via a bitmap, and bits in the bitmap correspond to the uplink resource locations.

In some possible implementations, in terms of determining the uplink power control to be used for each of the multiple uplink resource locations, the determining unit 602 is configured to: determine, according to location indication of the uplink resource location or according to a bitmap of the uplink resource location, an uplink power control parameter set to which the uplink resource location belongs; and determine, according to the uplink power control parameter set, the uplink power control to be used for the uplink resource location.

In some possible implementations, the same uplink power control parameter set includes one or more parameter set configurations, and the parameter set configuration includes a received target power spectrum and/or a pathloss compensation factor.

In some possible implementations, the same uplink power control parameter set includes one or more MCS power adjustments.

In some possible implementations, the same uplink power control parameter set includes one or more power control adjustment states.

In some possible implementations, the power control adjustment state is calculated in a TPC command accumulation manner, and in the TPC command accumulation manner, only TPC commands obtained in uplink resource locations belonging to the same uplink power control parameter set are accumulated.

In some possible implementations, the uplink resource location includes an uplink time-domain resource location and/or an uplink frequency-domain resource location. The uplink time-domain resource location includes one of a subframe, a slot, a symbol, and a mini slot. The uplink frequency-domain resource location includes one of a subband, a subcarrier, a RB, and a RE.

### VI. Exemplary Description of Another Uplink Power Control Apparatus

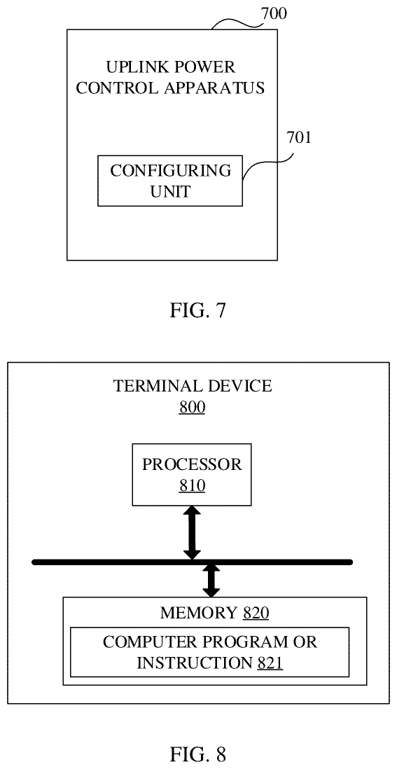

If an integrated unit is used, FIG. 7 is a block diagram illustrating functional units of an uplink power control apparatus according to embodiments of the disclosure. The uplink power control apparatus 700 includes a configuring unit 701.

In some possible implementations, the configuring unit 701 may be a module or unit configured to process signals, data, information, etc., which is not limited herein.

In some possible implementations, the uplink power control apparatus 700 may further include a storage unit configured to store computer program codes or instructions executed by the uplink power control apparatus 400. The storage unit may be a memory.

In some possible implementations, the uplink power control apparatus 700 may be a chip or a chip module.

In some possible implementations, the configuring unit 701 may be integrated into other units.

For example, the configuring unit 701 may be integrated in a communication unit. It may be noted that, the communication unit may be a communication interface, a transceiver, a transceiver circuit, or the like.

For another example, the configuring unit 701 may be integrated in a processing unit.

It may be noted that, the processing unit may be a processor or a controller, such as a baseband processor, a baseband chip, a CPU, a general-purpose processor, a DSP, an ASIC, an FPGA, or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the configuring unit 701 is configured to perform any operation performed by the network device/chip/chip module, etc. in above method embodiments, such as transmitting or receiving data, etc., which will be described in detail below.

In specific implementation, the configuring unit 701 is configured to perform any operation in above method embodiments, and when executing actions such as transmitting, other units can be selectively invoked to complete corresponding operations, which will be described in detail below.

The configuring unit 701 is configured to configure multiple uplink resource locations configured for uplink transmission. Uplink power control is used for each of the multiple uplink resource locations.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

It may be noted that, for the implementation of various operations in the embodiments illustrated in FIG. 7, reference can be made to the elaborations in the method embodiments above, which will not be repeated herein.

### 2. Some Possible Implementations

Some possible implementations will be described below. For some specific descriptions, reference can be made to the elaborations above, which will not be repeated herein.

In some possible implementations, among the multiple uplink resource locations, each uplink resource location is configured with an uplink power control parameter set to which the uplink resource location belongs. The uplink power control parameter set is used to configure a parameter and/or a TPC command in an uplink power control process. Independent uplink power control is used for each of uplink resource locations belonging to different uplink power control parameter sets.

In some possible implementations, among the multiple uplink resource locations, uplink resource locations belonging to the same uplink power control parameter set are configured.

In some possible implementations, uplink resource locations belonging to the same uplink power control parameter set are configured via location indication, and the location indication includes Type-1 location indication and/or Type-2 location indication. The Type-1 location indication indicates an index of an uplink resource location, and the Type-2 location indication indicates a belonging relationship between the uplink resource location and the uplink power control parameter set.

In some possible implementations, uplink resource locations belonging to the same uplink power control parameter set are configured via a bitmap, and bits in the bitmap correspond to the uplink resource locations in sequence.

In some possible implementations, the uplink power control to be used for each of the multiple uplink resource locations is determined as follows. An uplink power control parameter set to which the uplink resource location belongs is determined according to location indication of the uplink resource location or according to a bitmap of the uplink resource location. The uplink power control to be used for the uplink resource location is determined according to the uplink power control parameter set.

In some possible implementations, the same uplink power control parameter set includes one or more parameter set configurations, and the parameter set configuration includes a received target power spectrum and/or a pathloss compensation factor.

In some possible implementations, the same uplink power control parameter set includes one or more MCS power adjustments.

In some possible implementations, the same uplink power control parameter set includes one or more power control adjustment states.

In some possible implementations, the power control adjustment state is calculated in a TPC command accumulation manner, and in the TPC command accumulation manner, only TPC commands obtained in uplink resource locations belonging to the same uplink power control parameter set are accumulated.

In some possible implementations, the uplink resource location includes an uplink time-domain resource location and/or an uplink frequency-domain resource location. The uplink time-domain resource location includes one of a subframe, a slot, a symbol, and a mini slot. The uplink frequency-domain resource location includes one of a subband, a subcarrier, a RB, and a RE.

### VII. Exemplary Description of a Terminal Device

FIG. 8 is a schematic structural diagram of a terminal device according to embodiments of the disclosure. The terminal device 800 includes a processor 810, a memory 820, and a communication bus configured to connect the processor 810 and the memory 820.

In some possible implementations, the memory 820 includes but is not limited to a random access memory (RAM), a read-only memory (ROM), an erasable programmable read-only memory (EPROM), or a compact disc read-only memory (CD-ROM). The memory 820 is configured to store program codes executed by the terminal device 800 and data transmitted by the terminal device 800.

In some possible implementations, the terminal device 800 further includes a communication interface configured to receive and transmit data.

In some possible implementations, the processor 810 may be one or more CPUs. When the processor 810 is one CPU, the CPU may be a single-core CPU or a multi-core CPU.

In some possible implementations, the processor 810 may be a baseband chip, a chip, a CPU, a general-purpose processor, a DSP, an ASIC, an FPGA, or other programmable logic devices, transistor logic devices, hardware components, or any combination thereof.

In specific implementation, the processor 810 in the terminal device 800 is configured to execute a computer program or instruction 821 stored in the memory 820 to: obtain multiple uplink resource locations configured for uplink transmission; and determine uplink power control to be used for each of the multiple uplink resource locations.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

It may be noted that, for the implementation of various operations, reference can be made to the corresponding elaborations of the method embodiments above. The terminal device 800 may be configured to perform the foregoing method embodiments of the disclosure, which will not be repeated herein.

### VIII. Exemplary Description of a Network Device

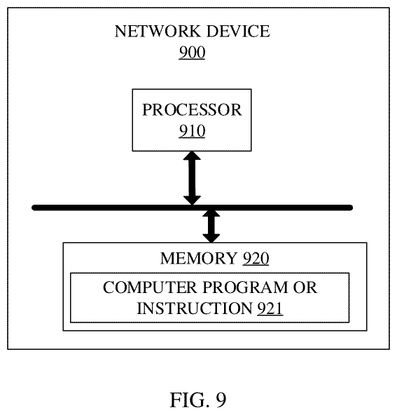

FIG. 9 is a schematic structural diagram of a network device according to embodiments of the disclosure. The network device 900 includes a processor 910, a memory 920, and a communication bus configured to connect the processor 910 and the memory 920.

In some possible implementations, the memory 920 includes but is not limited to an RAM, an ROM, an EPROM, or a CD-ROM. The memory 920 is configured to store related instructions and data.

In some possible implementations, the network device 900 further includes a communication interface configured to receive and transmit data.

In some possible implementations, the processor 910 may be one or more CPUs. When the processor 910 is one CPU, the CPU may be a single-core CPU or a multi-core CPU.

In some possible implementations, the processor 910 may be a baseband chip, a chip, a CPU, a general-purpose processor, a DSP, an ASIC, an FPGA, or other programmable logic devices, transistor logic devices, hardware components, or any combination thereof.

In specific implementation, the processor 910 in the network device 900 is configured to execute a computer program or instruction 921 stored in the memory 920 to: configure multiple uplink resource locations configured for uplink transmission. Uplink power control is used for each of the multiple uplink resource locations.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

It may be noted that, for the implementation of various operations, reference can be made to the corresponding elaborations of the method embodiments above. The network device 900 may be configured to perform the foregoing method embodiments of the disclosure, which will not be repeated herein.

### IX. Other Related Exemplary Descriptions

In some possible implementations, the above method embodiments may be applied to or in a terminal device. That is, the execution entity of the above method embodiments may be a terminal device, a chip, a chip module, or a module, etc., which is not limited herein.

In some possible implementations, the above method embodiments may be applied to or in a network device. That is, the execution subject of the above method embodiments may be a network device, a chip, a chip module, or a module, etc., which is not limited herein.

A chip is further provided in embodiments of the disclosure. The chip includes a processor, a memory, and a computer program or instruction stored in the memory. The processor is configured to execute the computer program or instruction to perform the operations of the above method embodiments.

A chip module is further provided in embodiments of the disclosure. The chip module includes a transceiver assembly and a chip. The chip includes a processor, a memory, and a computer program or instruction stored in the memory. The processor is configured to execute the computer program or instruction to perform the operations of the above method embodiments.

A computer-readable storage medium is further provided in embodiments of the disclosure. The computer-readable storage medium is configured to store a computer program or instruction which, when executed, is operable to implement the operations of the above method embodiments.

A computer program product is further provided in embodiments of the disclosure. The computer program product includes a computer program or instruction which, when executed, is operable to implement the operations of the above method embodiments.

A communication system is further provided in embodiments of the disclosure. The communication system includes the terminal device and the network device above.

An uplink power control method and apparatus, a terminal device, and a network device are provided in this disclosure, so as to solve the problem of how to enhance uplink power control, thereby improving flexibility and operability of the uplink power control and ensuring uplink transmission performance and reliability.

An uplink power control method is provided in this disclosure. The method includes the following. Multiple uplink resource locations configured for uplink transmission are obtained. Uplink power control to be used for each of the multiple uplink resource locations is determined.

As can be seen, from the perspective of the multiple uplink resource locations configured/scheduled for the uplink transmission, it is considered in embodiments of the disclosure that different types of interference may occur in different uplink resource locations. Then, for each of the multiple uplink resource locations, uplink power control to be used for the uplink resource location under an interference type that the uplink resource location belongs to/has/is associated with/corresponds to is determined according to network configuration, pre-configuration, or a specification in a protocol, etc.

As such, uplink power control can be enhanced by independently using the uplink power control for each of the uplink resource locations that belong to/have/are associated with/correspond to different interference types, thereby improving flexibility and operability of the uplink power control and ensuring uplink transmission performance and reliability under different types of interference.

An uplink power control method is provided in this disclosure. The method includes the following. Multiple uplink resource locations for uplink transmission are configured, where uplink power control is used for each of the multiple uplink resource locations.

An uplink power control apparatus is provided in this disclosure. The apparatus includes an obtaining unit and a determining unit. The obtaining unit is configured to obtain multiple uplink resource locations configured for uplink transmission. The determining unit is configured to determine uplink power control to be used for each of the multiple uplink resource locations.

An uplink power control apparatus is provided in this disclosure. The apparatus includes a configuring unit. The configuring unit is configured to configure multiple uplink resource locations for uplink transmission, where uplink power control is used for each of the multiple uplink resource locations.

A terminal device is provided in the disclosure. The terminal device includes a processor, a memory, and a computer program or instruction stored in the memory. The processor is configured to execute the computer program or instruction to implement the operations of the method related to the terminal device.

A network device is provided in the disclosure. The network device includes a processor, a memory, and a computer program or instruction stored in the memory. The processor is configured to execute the computer program or instruction to implement the operations of the method related to the network device.

A chip is provided in the disclosure. The chip includes a processor and a communication interface. The processor is configured to implement the operations of the method above.

A chip module is provided in the disclosure. The chip module includes a transceiver assembly and a chip. The chip includes a processor. The processor is configured to implement the operations of the method above.

A computer-readable storage medium is provided in the disclosure. The computer-readable storage medium is configured to store a computer program or instruction which, when executed, is operable to implement the operations of the method above. For example, the computer program or instruction is executed by a processor.

A computer program product is provided in the disclosure. The computer program product includes a computer program or instruction which, when executed, is operable to implement the operations of the method above. For example, the computer program or instruction is executed by a processor.

A communication system is provided in the disclosure. The communication system includes the terminal device and network device described above.

It may be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference can be made to related elaborations in other embodiments.

The operations of the method or algorithm described in embodiments of the disclosure may be implemented by means of hardware, or may be implemented by executing software instructions by a processor. The software instructions can be implemented by corresponding software modules, which can be stored in an RAM, a flash memory, an ROM, an EPROM, an electrically EPROM (EEPROM), registers, hard disk, mobile hard disk, compact disc (CD)-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in a terminal device or a management device. The processor and the storage medium may also be present as discrete components in the terminal device or the management device.

Those skilled in the art will appreciate that, all or part of functions described in embodiments of the disclosure can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc.

Each module/unit in various devices or products described in the foregoing embodiments may be a software module/unit or a hardware module/unit, or some may be a software module/unit and some may be a hardware module/unit. For example, with regard to various devices or products applied to or integrated into a chip, various modules/units included therein may all be realized by means of hardware such as a circuit. Alternatively, at least some of the modules/units may be realized by means of a software program run on a processor integrated into the chip, and the rest (if any) modules/units may be implemented by means of hardware such as a circuit. The same also applies to various devices or products applied to or integrated into a chip module or various devices or products applied to or integrated into a terminal device.

The objectives, technical solutions, and advantages of embodiments of the disclosure are described in detail in the foregoing implementations. It may be appreciated that, the foregoing elaborations are merely some implementations of embodiments of the disclosure, but are not intended to limit the protection scope of embodiments of the disclosure. Any modifications, equivalent replacements, improvements, and the like made based on the technical solutions of embodiments of the disclosure shall all fall within the protection scope of embodiments of the disclosure.

1. An uplink power control method, comprising:
obtaining a plurality of uplink resource locations configured for uplink transmission; and
determining uplink power control to be used for each of the plurality of uplink resource locations.

2. The method of claim 1, wherein
among the plurality of uplink resource locations, each uplink resource location is configured with an uplink power control parameter set to which the uplink resource location belongs;
the uplink power control parameter set is used to configure at least one of a parameter or a transmit power control (TPC) command in an uplink power control process; and
independent uplink power control is used for each of uplink resource locations belonging to different uplink power control parameter sets.

3-6. (canceled)

7. The method of claim 2, wherein a same uplink power control parameter set comprises one or more parameter set configurations, and the parameter set configuration comprises at least one of a received target power spectrum or a pathloss compensation factor.

8. (canceled)

9. The method of claim 2, wherein a same uplink power control parameter set comprises one or more power control adjustment states.

10. The method of claim 9, wherein the power control adjustment state is calculated in a TPC command accumulation manner, and in the TPC command accumulation manner, only TPC commands obtained in uplink resource locations belonging to the same uplink power control parameter set are accumulated.

11. (canceled)

12. An uplink power control method, comprising:
configuring a plurality of uplink resource locations for uplink transmission, wherein uplink power control is used for each of the plurality of uplink resource locations.

13. The method of claim 12, wherein
among the plurality of uplink resource locations, each uplink resource location is configured with an uplink power control parameter set to which the uplink resource location belongs;
the uplink power control parameter set is used to configure at least one of a parameter or a transmit power control (TPC) command in an uplink power control process; and
independent uplink power control is used for each of uplink resource locations belonging to different uplink power control parameter sets.

14-17. (canceled)

18. The method of claim 13, wherein a same uplink power control parameter set comprises one or more parameter set configurations, and the parameter set configuration comprises at least one of a received target power spectrum or a pathloss compensation factor.

19. (canceled)

20. The method of claim 13, wherein a same uplink power control parameter set comprises one or more power control adjustment states.

21. The method of claim 20, wherein the power control adjustment state is calculated in a TPC command accumulation manner, and in the TPC command accumulation manner, only TPC commands obtained in uplink resource locations belonging to the same uplink power control parameter set are accumulated.

22. (canceled)

23-24. (canceled)

25. A terminal device, comprising:
a memory for storing a computer program or instruction; and
a processor coupled with the memory and configured to execute the computer program or instruction to:
obtain a plurality of uplink resource locations configured for uplink transmission; and
determine uplink power control to be used for each of the plurality of uplink resource locations.

26-28. (canceled)

29. The terminal device of claim 25, wherein
among the plurality of uplink resource locations, each uplink resource location is configured with an uplink power control parameter set to which the uplink resource location belongs;
the uplink power control parameter set is used to configure at least one of a parameter or a transmit power control (TPC) command in an uplink power control process; and
independent uplink power control is used for each of uplink resource locations belonging to different uplink power control parameter sets.

30. The terminal device of claim 29, wherein a same uplink power control parameter set comprises one or more parameter set configurations, and the parameter set configuration comprises at least one of a received target power spectrum or a pathloss compensation factor.

31. The terminal device of claim 29, wherein a same uplink power control parameter set comprises one or more power control adjustment states.

32. The terminal device of claim 31, wherein the power control adjustment state is calculated in a TPC command accumulation manner, and in the TPC command accumulation manner, only TPC commands obtained in uplink resource locations belonging to the same uplink power control parameter set are accumulated.
